(19) United States
(12) Patent Application Publication
(10) Pub. No.: US 2026/0201188 A1
(43) Pub. Date: Jul. 16, 2026

(54) RED-LIGHT BLOCKING INK BINDER FOR CONTACT LENSES

(71) Applicant: Bausch + Lomb Ireland Limited, Dublin (IE)

(72) Inventors: Sankarsan Biswas, Rochester, NY (US); Alok Kumar Awasthi, Pittsford, NY (US); Feng-Yang Shih, Lafayette, CO (US)

(21) Appl. No.: 19/448,696

(22) Filed: Jan. 14, 2026

Related U.S. Application Data
(60) Provisional application No. 63/745,143, filed on Jan. 14, 2025.

(51) Int. Cl. C09D 11/102; B29D 11/00; C09D 11/037; G02C 7/04; G02C 7/10

(52) U.S. Cl. CPC C09D 11/102; C09D 11/037; G02C 7/04; G02C 7/108; B29D 11/00125; B29D 11/00903

(57) ABSTRACT

A red-light blocking ink binder includes (a) a solvent, (b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, with (ii) a monomer having a reactive functionality complementary to the hydroxyl moiety of the hydroxyethyl acrylate monomer and a polymerizable ethylenically unsaturated reactive end group; and (c) a red-light blocking compound blocking from about 95% to about 98% of red-light transmission through a colored contact lens at a wavelength of from about 550 nanometers (nm) to about 800 nm.

### PRIORITY CLAIM

The present application claims priority to U.S. Provisional Patent Application Ser. No. 63/745,143, entitled “Red-Light Blocking Ink Binder for Contact Lenses,” filed Jan. 14, 2025, the content of which is incorporated by reference herein in its entirety.

### BACKGROUND

Contact lenses are made of various polymeric materials, including rigid gas permeable materials, soft elastomeric materials, and soft hydrogel materials. The majority of contact lenses sold today are made of soft hydrogel materials. Hydrogels are a cross-linked polymeric system that absorb and retain water, typically 10 to 80 percent by weight. Hydrogel lenses are commonly prepared by polymerizing a lens-forming monomeric mixture. In the case of silicone hydrogel lenses, a silicone-containing monomer is copolymerized with a hydrophilic monomer.

For cosmetic purposes, contact lenses having one or more colorants dispersed in the lens or printed on the lens are in high demand. These colored contact lenses enhance the natural beauty of the eye, or provide unique patterns on the iris of the wearer, or provide non cosmetic patterns or marks, such as rotation marks, inversion marks, product/brand codes, lot numbers, “DEMO” lenses, and the like, which are of benefits to wearers, eye-care practitioners and manufacturers.

### SUMMARY

In accordance with an illustrative embodiment, a red-light blocking ink binder comprises:
(a) a solvent,
(b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, with (ii) a monomer having a reactive functionality complementary to the hydroxyl moiety of the hydroxyethyl acrylate monomer and a polymerizable ethylenically unsaturated reactive end group, and
(c) a red-light blocking compound blocking from about 95% to about 98% of red-light transmission through a colored contact lens at a wavelength of from about 550 nanometers (nm) to about 800 nm.

In accordance with another illustrative embodiment, a colored contact lens comprises a pupil section, an iris section having an area and circumferentially surrounding the pupil section, and a colored pattern extending across a portion of the area of the iris section in a geometrical configuration to provide from about 95% to about 98% blocking of red-light transmission through the colored contact lens at a wavelength of from about 550 nanometers (nm) to about 800 nm, the colored pattern comprising a polymerization product of a red-light blocking ink binder comprising:
(a) a solvent,
(b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, and (c) a red-light blocking compound blocking from about 95% to about 98% of red-light transmission through the colored contact lens at a wavelength of from about 550 nm to about 800 nm, with (ii) a monomer having a reactive functionality complementary to the hydroxyl moiety of the hydroxyethyl acrylate monomer and a polymerizable ethylenically unsaturated reactive end group, and
(c) a red-light blocking compound blocking from about 95% to about 98% of red-light transmission through a colored contact lens at a wavelength of from about 550 nanometers (nm) to about 800 nm.

In accordance with yet another illustrative embodiment, a method comprises:
(a) applying, to at least a portion of a molding surface of a contact lens mold, a red-light blocking ink binder comprising (i) a solvent, (ii) a silicone copolymer comprising a reaction product of (1) a copolymerization product of a polymerization composition comprising (i1) an alkylacrylamide monomer, (12) a hydroxyethyl acrylate monomer, (i3) a non-bulky organosilicon-containing monomer having an ethylenically unsaturated reactive end group, and (14) a bulky siloxane monomer having an ethylenically unsaturated reactive end group, with (2) a monomer having a reactive functionality complementary to the hydroxyl moiety of the hydroxyethyl acrylate monomer and a polymerizable ethylenically unsaturated reactive end group, and (iii) a red-light blocking compound blocking from about 95% to about 98% of red-light transmission through a colored contact lens at a wavelength of from about 550 nanometers (nm) to about 800 nm, and
(b) curing the red-light blocking ink binder to form a colored pattern which comprises a red-light blocking polymer network comprising the red-light blocking compound in the polymer network, wherein the colored pattern contains a first surface in contact with the molding surface and an exposed second surface.

In accordance with still yet another illustrative embodiment, a method for making a colored contact lens comprising a pupil section, and an iris section having an area and circumferentially surrounding the pupil section, the method comprises:
(a) applying, to at least a portion of a molding surface of a contact lens mold, a red-light blocking ink binder comprising (i) a solvent, (ii) a silicone copolymer comprising a reaction product of (1) a copolymerization product of a polymerization composition comprising (i1) an alkylacrylamide monomer, (12) a hydroxyethyl acrylate monomer, (i3) a non-bulky organosilicon-containing monomer having an ethylenically unsaturated reactive end group, and (14) a bulky siloxane monomer having an ethylenically unsaturated reactive end group, with (2) a monomer having a reactive functionality complementary to the hydroxyl moiety of the hydroxyethyl acrylate monomer and a polymerizable ethylenically unsaturated reactive end group, and (iii) a red-light blocking compound blocking from about 95% to about 98% of red-light transmission through a colored contact lens at a wavelength of from about 550 nanometers (nm) to about 800 nm,
(b) curing the red-light blocking ink binder to form a colored pattern which comprises a red-light blocking polymer network comprising the red-light blocking compound in the polymer network, wherein the colored pattern contains a first surface in contact with the molding surface and an exposed second surface,
(c) dispensing a contact lens-forming mixture comprising a contact lens-forming material into the contact lens mold having the colored pattern,

(d) curing the contact lens-forming mixture comprising the contact lens-forming material to form a colored contact lens, whereby the colored pattern detaches from the molding surface and becomes integral with the body of the colored contact lens, the colored pattern extending across a portion of the area of the iris section in a geometrical configuration to provide from about 95% to about 98% blocking of red-light transmission through the colored contact lens at a wavelength of from about 550 nm to about 800 nm, and

(e) hydrating the colored contact lens.

### BRIEF DESCRIPTION OF THE DRAWING

In combination with the accompanying drawing and with reference to the following detailed description, the features, advantages, and other aspects of the implementations of the present disclosure will become more apparent, and several implementations of the present disclosure are illustrated herein by way of example but not limitation. In the accompanying drawing:

FIG. 1 illustrates a schematic plan view of a colored contact lens, according to an illustrative embodiment.

### DETAILED DESCRIPTION

Various illustrative embodiments described herein include a red-light blocking ink binder and colored contact lenses made therefrom.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

A “prepolymer” refers to a starting polymer which can be cured (e.g., crosslinked and/or polymerized) actinically or thermally or chemically to obtain a crosslinked and/or polymerized polymer having a molecular weight higher than the molecular weight of the starting polymer.

A “crosslinkable prepolymer” refers to a starting polymer which can be crosslinked to obtain a crosslinked polymer having a molecular weight higher than the molecular weight of the starting polymer.

A “colorant” refers to either a dye or a pigment or a mixture thereof that is used to print a color image on an article.

A “dye” refers to a substance that is soluble in a solvent and that is used to impart color. A dye is typically translucent and absorb but do not scatter light. A dye can cover both optical regions of contact lenses and non-optical regions of contact lenses. Nearly any dye can be used in the present disclosure, so long as it can be used in an apparatus as described below. These dyes include fluorescent dyes, phosphorescent dyes, and conventional dyes.

A “pigment” refers to a powdered substance that is suspended in a liquid in which it is insoluble. A pigment can be used to impart color. Pigments, in general, are more opaque than dyes.

The term “hydrogel” or “hydrogel material” as used herein refers to a crosslinked polymeric material that has a three-dimensional polymer network (i.e., polymer matrix), is insoluble in water, but can hold at least about 10 percent by weight of water in its polymer matrix when it is fully hydrated.

The term “silicone hydrogel” or “SiHy” as used herein interchangeably refers to a hydrogel containing silicone. A silicone hydrogel (SiHy) typically is obtained by copolymerization of a polymerizable composition comprising at least one contact lens-forming material.

The term “(meth)” as used herein denotes an optional methyl substituent. Thus, terms such as “(meth)acrylate” denotes either methacrylate or acrylate, and “(meth)acrylamide” denotes either methacrylamide or acrylamide.

A “contact lens” refers to contact lenses that reside in or on the eye. These lenses can provide optical correction, wound care, drug delivery, diagnostic functionality or cosmetic enhancement or effect or a combination of these properties. Suitable contact lenses include, for example, contact lenses such as soft contact lenses, e.g., a soft, hydrogel lens; soft, non-hydrogel lens and the like, hard contact lenses, e.g., a hard, gas permeable lens material, a hybrid lens and the like. A contact lens can be in a dry state or a wet state. A “dry state” refers to a soft contact lens in a state prior to hydration or the state of a hard lens under storage or use conditions. A “wet state” refers to a soft contact lens in a hydrated state. As is understood by one skilled in the art, a contact lens is considered to be “soft” if it can be folded back upon itself without breaking. A contact lens can be tinted before printing any color patterns.

While compositions and processes are described in terms of “comprising” various components or steps, the compositions and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means+20% of the stated value, =15% of the stated value, +10% of the stated value, +5% of the stated value, +3% of the stated value, or +1% of the stated value.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Myopia (“nearsightedness”) is a vision condition where objects near to a viewer appear clear, but objects that are spaced farther away from the viewer get progressively blurred. Myopia can be caused by multiple reasons. One factor in many cases of myopia is an elongated axial length of the eye. Myopia occurs when the focal point of the focused light is formed before the retina. In other words, the focal point of the light rays entering the eye stop short of the retina. Thus, myopic eyes focus in front of the retinal plane. Myopia typically develops because the axial length of the eye grows to be longer than the focal length of the optical components of the eye, that is, the eye grows too long.

It is believed that excessive stimulation of L cones in a person's eye (especially in children), may result in non-optimal eye lengthening and myopia. By spectrally filtering red-light using a contact lens containing red-light blocking compound, myopia can be further reduced in a wearer. However, present dyes (or colorants) of such red-light blocking compounds typically used to manufacture tinted soft contact lenses often leach out and the lenses lose their original tint when subjected to sterilization conditions or during prolonged storage. Thus, there is a need for an improved contact lens which can filter and/or block red-light thereby inhibiting or preventing myopia in a wearer of the contact lens.

The non-limiting illustrative embodiments disclosed herein overcome the foregoing drawbacks by providing a red-light blocking ink binder that can form a colored pattern on a contact lens in a geometrical configuration to advantageously provide for at least one of slowing, inhibiting or preventing myopia progression by blocking from about 95% and up to about 98% of red-light transmission through the colored contact lens at a wavelength of from about 550 nanometers (nm) to about 800 nm. The red-light blocking ink binder can also form a colored pattern on a contact lens without any ink domain expansion after being hydrated. Thus, the present disclosure is partly based on the discovery that when the silicone copolymer disclosed herein is used in a red-light blocking ink binder containing a red-light blocking compound blocking from about 95% to about 98% of red-light transmission through a colored contact lens at a wavelength of from about 550 nm to about 800 nm for making colored contact lenses by using a print-on-mold process, the expansion of colored pattern will be comparable to the expansion of the contact lens during hydration, while also providing for at least one of slowing, inhibiting or preventing myopia progression by blocking from about 95% and up to about 98% of red-light transmission through colored contact lens at a wavelength of from about 550 nm to about 800 nm.

In non-limiting illustrative embodiments, a red-light blocking ink binder of the present disclosure includes at least (a) a solvent, (b) a silicone copolymer comprising a reaction product of (i) a copolymerization product of a polymerization composition comprises (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, with (ii) a monomer having a reactive functionality complementary to the hydroxyl moiety of the hydroxyethyl acrylate monomer and a polymerizable ethylenically unsaturated reactive end group, and (c) a red-light blocking compound blocking from about 95% to about 98% of red-light transmission through a colored contact lens at a wavelength of from about 550 nm to about 800 nm.

In some embodiments, a solvent can be water, an organic or inorganic solvent, a mixture of several organic solvents, or a mixture of water and one or more water soluble or water miscible organic solvents. Any known solvents can be used, so long as they can dissolve the silicone copolymer and red-light blocking compound in the red-light blocking ink binder of the present disclosure. Suitable solvents include, for example, water, acetone, alcohols (e.g., methanol, ethanol, propanol, isopropanol, 2-ethyoxyethanol, etc.), glycols, ketones, esters, cyclopentanone, cyclohexanone, tetrahydrofuran, acetone, methyl-2-pyrrolidone, dimethyl formamide, acetophenone, methylene dichloride, dimethyl sulfoxide, gamma-butyrolactone, ethylene dichloride, isophorone, o-dichlorobenzene, tetrahydrofuran, diacetone alcohol, methyl ethyl ketone, acetone, 2-nitropropane, ethylene glycol monoethyl ether, propylene carbonate, cyclohexanol, chloroform, trichloroethylene, 1,4-dioxane, ethyl acetate, ethyl lactate, ethylene glycol monobutyl ether, chlorobenzene, nitroethane, ethylene glycol monomethyl ether, butyl acetate, 1-butanol, methyl isobutyl ketone, nitromethane, toluene, ethanol, diethylene glycol, benzene, diethyl ether, ethanolamine, carbon tetrachloride, propylene glycol, hexane, ethylene glycol, and formamide.

In non-limiting illustrative embodiments, a silicone copolymer comprises a reaction product of (a) a copolymerization product of a polymerization composition comprises (i) an alkylacrylamide monomer, (ii) a hydroxyethyl acrylate monomer, (iii) a non-bulky organosilicon-containing monomer having an ethylenically unsaturated reactive end group, and (iv) a bulky siloxane monomer having an ethylenically unsaturated reactive end group, with (b) a monomer having a reactive functionality complementary to the hydroxyl moiety of the hydroxyethyl acrylate monomer and a polymerizable ethylenically unsaturated reactive end group.

In some embodiments, an alkylacrylamide monomer for use in the polymerization composition includes, for example, N,N-dimethylacrylamide, N,N-dimethylmethacrylamide, and the like.

In some embodiments, the polymerization composition can contain from about 20 wt. % to about 60 wt. %, based on the total weight of the polymerization composition, of the alkylacrylamide monomer. In some embodiments, the polymerization composition can contain from about 40 wt. % to about 45 wt. %, based on the total weight of the polymerization composition, of the alkylacrylamide monomer.

In some embodiments, a hydroxyethyl acrylate monomer for use in the polymerization composition is represented by the following structure:

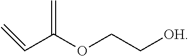

In some embodiments, the polymerization composition can contain from about 0.01 wt. % to about 40 wt. %, based on the total weight of the polymerization composition, of the hydroxyethyl acrylate monomer. In some embodiments, the polymerization composition can contain from about 20 wt. % to about 30 wt. %, based on the total weight of the polymerization composition, of the hydroxyethyl acrylate monomer.

The polymerization composition further includes a non-bulky organosilicon-containing monomer having an ethylenically unsaturated reactive end group. An “organosilicon-containing monomer” as used herein contains at least one [siloxanyl] or at least one [silyl-alkyl-siloxanyl]repeating unit, in a monomer, macromer or prepolymer. In an illustrative embodiment, an example of a non-bulky organosilicon-containing monomers is represented by a structure of Formula Ia:

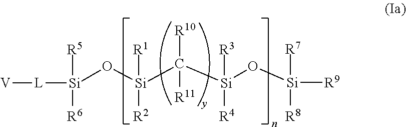

wherein Vis an ethylenically unsaturated polymerizable group, L is a linking group or a bond; R¹, R², R³, R⁴, R⁵, R⁶, R⁷, R⁸, and R° are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, O-vinyl carbamates, N-vinyl carbamates, and (meth)acrylamides.

Linking groups can be any divalent radical or moiety and include, for example, a substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In one embodiment, V is a (meth)acrylate, L is a C₁ to C₁₂ alkylene group, R¹, R², R³, R⁴, R⁵, R⁶, R⁷, R⁸, and R¹⁰ are independently a C₁ to C₁₂ alkyl group, R¹⁰ and R¹¹ are independently H or a C₁ to C₁₂ alkyl group, y is 2 to 7 and n is 3 to 8.

In one embodiment, V is a (meth)acrylate, L is a C₁ to C₆ alkyl group, R¹, R², R³, R⁴, R⁵, R⁶, R⁷, R⁸, and R° are independently a C₁ to C₆ alkyl group, R¹⁰ and R¹¹ are independently H or a C₁ to C₆ alkyl group, y is 2 to 7 and n is 1 to 20.

Non-bulky organosilicon-containing monomers represented by a structure of Formula Ia are known in the art, see, e.g., U.S. Pat. Nos. 7,915,323, 7,994,356, 8,420,711, 8,827,447 and 9,039,174, the contents of which are incorporated by reference herein.

In an illustrative embodiment, as may be combined with one or more of the preceding paragraphs, an example of a non-bulky organosilicon-containing monomer is represented by a structure of Formula Ib:

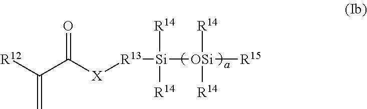

wherein R¹² is H or methyl; X is O or NR¹⁶, wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula Ib are known in the art, see, e.g., U.S. Pat. Nos. 8,703,891, 8,937,110, 8,937,111, 9,156,934 and 9,244,197, the contents of which are incorporated by reference herein.

Representative examples of non-bulky organosilicon-containing monomers for use herein include:

M1EDS6: a compound having the structure and available from Gelest:

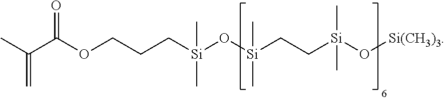

MCR-M11: a compound having the structure:

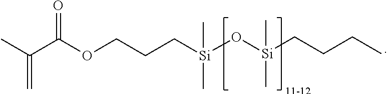

M1-MCR-C₁₂: a compound having the structure:

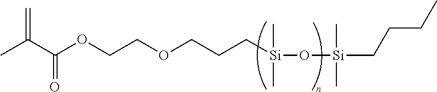

wherein n is an average of 12.

In some embodiments, the polymerization composition can contain from about 0.10 wt. % to about 30 wt. %, based on the total weight of the polymerization composition, of a non-bulky organosilicon-containing monomer. In some embodiments, the polymerization composition can contain from about 5 wt. % to about 15 wt. %, based on the total weight of the polymerization composition, of a non-bulky organosilicon-containing monomer.

The polymerization composition further includes a bulky siloxane monomer having an ethylenically unsaturated reactive end group. The term “bulky” refers to groups on the siloxane monomer that are sterically and/or electronically encumbering, i.e., sterically hindering. In a non-limiting illustrative embodiment, suitable bulky silicone-containing monomers include, for example, a bulky polysiloxanylalkyl (meth)acrylic monomer, a bulky polysiloxanylalkyl carbamate monomer and mixtures thereof. In one embodiment, a representative example of a bulky silicone-containing monomer is represented by a structure of Formula II:

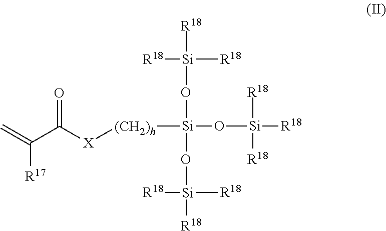

wherein X denotes —O— or —NR¹⁹—, where each R¹⁹ is hydrogen or a C₁-C₄ alkyl group; R¹⁷ independently denotes hydrogen or methyl; each R¹⁸ independently denotes a lower alkyl radical such as a C₁-C₆ group, a phenyl radical or a group represented by the following structure:

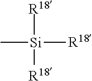

wherein each R¹⁸′ independently denotes a lower alkyl radical such as a C₁-C₆ group or a phenyl radical; and his 1 to 10; or is represented by a structure of Formula III:

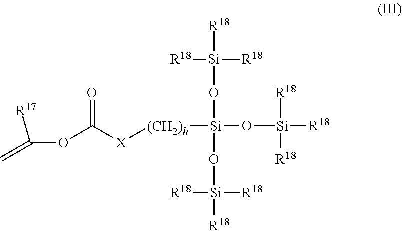

wherein X denotes —NR¹⁹— wherein R¹⁹ denotes hydrogen or a C₁-C₄ alkyl; R¹⁷ denotes hydrogen or methyl; each R¹⁸ independently denotes a lower alkyl radical such as a C₁-C₆ group, a phenyl radical or a group represented by the following structure:

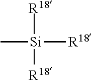

wherein each R¹⁸′ independently denotes a lower alkyl radical such as a C₁-C₆ group or a phenyl radical; and h is 1 to 10.

Representative examples of bulky silicone-containing monomers include 3-methacryloyloxypropyltris(trimethylsiloxy) silane or tris(trimethylsiloxy) silylpropyl methacrylate, sometimes referred to as TRIS and tris(trimethylsiloxy) silylpropyl vinyl carbamate, sometimes referred to as TRIS-VC, pentamethyldisiloxanyl methylmethacrylate, phenyltetramethyl-disiloxanylethyl acetate, and methyldi (trimethylsiloxy) methacryloxymethyl silane, (3-methacryloxy-2-hydroxy propoxy) propyl bis(trimethylsiloxy)methyl silane, sometimes referred to as Sigma and the like and mixtures thereof. In one embodiment, the bulky silicone-containing monomer is a tris(trialkylsiloxy) silylalkyl methacrylate-containing monomer such as a tris(trimethylsiloxy) silylpropyl methacrylate-containing monomer.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

In some embodiments, the polymerization composition can contain from about 5 wt. % to about 30 wt. %, based on the total weight of the polymerization composition, of a bulky organosilicon-containing monomer. In some embodiments, the polymerization composition can contain from about 15 wt. % to about 25 wt. %, based on the total weight of the polymerization composition, of a bulky organosilicon-containing monomer.

In an illustrative embodiment, as may be combined with one or more of the preceding paragraphs, a copolymerization product of a polymerization composition comprising (i) an alkylacrylamide monomer, (ii) a hydroxyethyl acrylate monomer, (iii) a non-bulky organosilicon-containing monomer having an ethylenically unsaturated reactive end group, and (iv) a bulky siloxane monomer having an ethylenically unsaturated reactive end group can be prepared using free radical polymerization techniques with the structure of the polymer being completely random or controlled by the reactivity ratios of the respective monomers.

In some embodiments, a random copolymer can be obtained by (1) mixing the components to obtain a polymerization composition, (2) adding a polymerization initiator to the polymerization composition, and (3) subjecting the monomer/initiator mixture to a source of heat or radiation such as ultraviolet light, visible light, or high energy radiation to obtain a copolymerization product as discussed below. Suitable free radical thermal polymerization initiators include acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN), and the like. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy), 2,2′ Azobis(2-methylpropionitrile) (Vazo 64) and the like. Generally, the initiator will be employed in the mixture at a concentration of about 0.01 to about 5 percent by weight of the total mixture.

Suitable polymerization conditions include, for example, a temperature of between about 60° C. to about 100° C. for a time period of about 30 minutes to about 48 hours. If desired, the reaction can be carried out in the presence of a suitable solvent. Suitable solvents are in principle all solvents which dissolve the monomers used including, for example, 1,4-dioxane, hexanol, dimethylformamide; acetone, cyclohexanone, toluene, and the like and mixtures thereof.

The copolymerization product disclosed herein can also be prepared using techniques of controlled radical polymerization, e.g., by reversible addition-fragmentation chain transfer (RAFT) polymerization or atom-transfer radical polymerization (ATRP) employing a chain transfer agent that allows construction of copolymers with a well-defined molecular weight distribution and narrow polydispersity. RAFT polymerization is particularly preferred because it is compatible with a wide variety of vinyl monomers.

In non-limiting illustrative embodiments, the RAFT agents suitable for use herein can be based upon thio carbonyl thio chemistry which is well known to those of ordinary skill in the art. The thio carbonyl thio fragment can be derived from a RAFT agent such as, for example, a xanthate-containing compound, trithiocarbonate-containing compound, dithiocarbamate-containing compound, a dithiobenzoate-containing compound or dithio ester-containing compound, wherein each compound contains a thio carbonyl thio group. One class of RAFT agents that can be used herein is of the general formula:

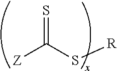

wherein x is 1 or 2, Z is a substituted oxygen (e.g., xanthates (—O—R)), a substituted nitrogen (e.g., dithiocarbamates (—NRR)), a substituted sulfur (e.g., trithiocarbonates (—S—R)), a dithiobenzoate, a substituted or unsubstituted C₁-C₂₀ alkyl or C₃-C₂₅ unsaturated, or partially or fully saturated ring (e.g., dithioesters (—R)) or carboxylic acid-containing group; and R is independently a straight or branched, substituted or unsubstituted C₁-C₃₀ alkyl cyano group, a straight or branched, substituted or unsubstituted C₁-C₃₀ alkyl group, a substituted or unsubstituted C₃-C₃₀ cycloalkyl group, a substituted or unsubstituted C₃-C₃₀ cycloalkylalkyl group, a substituted or unsubstituted C₃-C₃₀ cycloalkenyl group, a substituted or unsubstituted C₅-C₃₀ aryl group, a substituted or unsubstituted C₅-C₃₀ arylalkyl group, a C₁-C₂₀ ester group; an ether or polyether-containing group; an alkyl- or arylamide group; an alkyl- or arylamine group; a substituted or unsubstituted C₅-C₃₀ heteroaryl group; a substituted or unsubstituted C₃-C₃₀ heterocyclic ring; a substituted or unsubstituted C₄-C₃₀ heterocycloalkyl group; a substituted or unsubstituted C₆-C₃₀ heteroarylalkyl group; and combinations thereof.

The substituents in the ‘substituted oxygen’, ‘substituted nitrogen’, ‘substituted sulfur’, ‘substituted alkyl’, ‘substituted alkylene, ‘substituted cycloalkyl’, ‘substituted cycloalkylalkyl’, ‘substituted cycloalkenyl’, ‘substituted arylalkyl’, ‘substituted aryl’, ‘substituted heterocyclic ring’, ‘substituted heteroaryl ring,’ ‘substituted heteroarylalkyl’, ‘substituted heterocycloalkyl ring’, ‘substituted cyclic ring’ may be the same or different and include one or more substituents such as hydrogen, hydroxy, halogen, carboxyl, cyano, nitro, oxo (═O), thio (═S), substituted or unsubstituted alkyl, substituted or unsubstituted alkoxy, substituted or unsubstituted alkenyl, substituted or unsubstituted alkynyl, substituted or unsubstituted aryl, substituted or unsubstituted arylalkyl, substituted or unsubstituted cycloalkyl, substituted or unsubstituted cycloalkenyl, substituted or unsubstituted amino, substituted or unsubstituted aryl, substituted or unsubstituted heteroaryl, substituted heterocycloalkyl ring, substituted or unsubstituted heteroarylalkyl, substituted or unsubstituted heterocyclic ring, and the like.

Representative examples of RAFT agents for use herein include, but are not limited to, 4-cyano-4-(dodecyl-sulfanylthiocarbonyl) sulfanylpentanoic acid, S-cyanomethyl-5-dodecyltrithiocarbonate, S-(2-cyano-2-propyl)-S-dodecyltrithiocarbonate, 3-benzylsulfanylthiocarbonylsulfanyl-propionic acid, cumyl dithiobenzoate, 2-cyanoprop-2-yl dithiobenzoate (i.e., cyanoisopropyl dithiobenzoate), 4-thiobenzoylsulfanyl-4-cyanopentanoic acid (TCA), S,S′-bis(a,a′-dimethyl-alpha″-acetic acid)-trithiocarbonate (BATC), benzyl dodecyl trithiocarbonate, ethyl-2-dodecyl trithiocarbony) proprionate, S-sec propionic acid O-ethyl xanthate, a-ethyl xanthylphenylacetic acid, ethyl α-(o-ethyl xanthyl) proprionate, ethyl α-(ethyl xanthyl)phenyl acetate, ethyl 2-(dodecyl trithiocarbonyl)phenyl acetate, ethyl 2-(dodecyl trithiocarbonyl) propionate, 2-(dodecylthiocarbonylthiol) propanoic acid, and the like and mixtures thereof.

There is no particular limitation on the organic chemistry used to form the RAFT agent and is within the purview of one skilled in the art.

The copolymerization product disclosed herein can be obtained by (1) mixing an alkylacrylamide monomer, a hydroxyethyl acrylate monomer, a non-bulky organosilicon-containing monomer having an ethylenically unsaturated reactive end group, and a bulky siloxane monomer having an ethylenically unsaturated reactive end group with a RAFT agent and a polymerization initiator, and (2) subjecting the monomer/RAFT agent/initiator mixture to a source of heat. Suitable initiators include, for example, free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobisisobutyronitrile (AIBN).

The reaction can be carried out at a temperature of between about 50° C. to about 80° C. for a time period of about 30 minutes to about 48 hours. If desired, the reaction can be carried out in the presence of a suitable solvent. Suitable solvents are in principle all solvents which dissolve the monomer used, for example, 1,4-dioxane, hexanol, dimethylformamide; acetone, cyclohexanone, toluene, and the like and mixtures thereof.

In an illustrative embodiment, the RAFT procedure is carried using a mixture including (i) from about 2 wt. % to about 40 wt. %, based on the total weight of the mixture, of an alkylacrylamide monomer, (ii) from about 10 wt. % to about 20 wt. %, based on the total weight of the mixture, of a hydroxyethyl acrylate monomer, (iii) from about 10 wt. % to about 60 wt. %, based on the total weight of the mixture, of a non-bulky organosilicon-containing monomer having an ethylenically unsaturated reactive end group, and (iv) from about 20 wt. % to about 60 wt. %, based on the total weight of the mixture, of a bulky siloxane monomer having an ethylenically unsaturated reactive end group, and (v) from about 0.05 wt. % to about 2 wt. %, based on the total weight of the mixture, of the RAFT agent. The level of initiator employed will vary within the range of 0.01 wt. % to 2 wt. % of the mixture of monomers. In some embodiments, the mixture for the RAFT procedure further includes from about 0.1 to about 5 wt. %, based on the total weight of the mixture, of an ultraviolet blocker having an ethylenically unsaturated reactive group.

A non-limiting schematic representation of a synthetic method for making a copolymerization product with a RAFT agent is set forth below in Scheme I below.

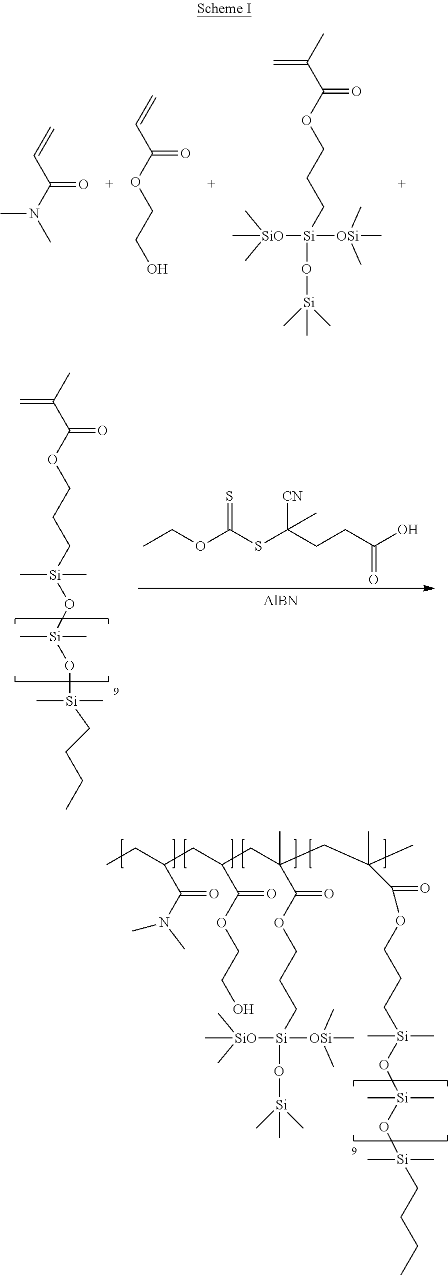

In the case where the copolymerization product disclosed herein is obtained from ATRP polymerization, the ethylenically unsaturated groups may be introduced by appropriate selection of a suitable ATRP initiator or by displacement reactions of the terminal halogen atom. Suitable ATRP groups for use herein include any standard monofunctional or difunctional ATRP group as is well known to those of ordinary skill in the art. A comprehensive review on the use of ATRP initiators or displacement of the terminal halogen using electrophilic, nucleophilic, and radical reactions to produce telechelic polymers is disclosed in, for example, Matyjaszewski, K.; Xia, J. Chem. Rev., 101, 2921-2990 (2001).

In one embodiment, a useful ATRP group includes an ethylenically unsaturated ATRP initiator such as, for example, vinyl functionalized ATRP initiators, e.g., prop-2-enyl-2′-bromoisobutyrate, vinyl chloroacetate, allyl chloroacetate, allyl bromide and the like.

In another embodiment, a useful ATRP group includes a non-ethylenically unsaturated ATRP initiator that can be converted to an ethylenically unsaturated initiator by a subsequent step. Examples of such initiators include α-bromo-isobutyric acid, hydroxyethyl 2-bromopropionate, glycidol 2-bromopropionate, tert-butyl 2-bromopropionate, and 4-bromobenzyl bromide, and the like.

In an illustrative embodiment, the copolymerization product is obtained from ATRP polymerization by (1) mixing an alkylacrylamide monomer, a hydroxyethyl acrylate monomer, a non-bulky organosilicon-containing monomer having an ethylenically unsaturated reactive end group, and a bulky siloxane monomer having an ethylenically unsaturated reactive end group with a suitable ATRP catalyst such as a copper (I) bromide and (2) subjecting the monomer/ATRP agent/initiator mixture to a source of heat.

The reaction can be carried out at a temperature of between about 60° C. to about 100° C. for a time period of about 30 minutes to about 48 hours. If desired, the reaction can be carried out in the presence of a suitable solvent. Suitable solvents are in principle all solvents which dissolve the monomer used, for example, 1,4-dioxane, hexanol, dimethylformamide; acetone, cyclohexanone, toluene, and the like and mixtures thereof.

In an illustrative embodiment, the ATRP procedure is carried using a mixture including (i) from about 0.1 wt. % to about 20 wt. %, based on the total weight of the mixture, of an alkylacrylamide monomer, (ii) from about 5 wt. % to about 20 wt. %, based on the total weight of the mixture, of a hydroxyethyl acrylate monomer, (iii) from about 10 wt. % to about 20 wt. %, based on the total weight of the mixture, of a non-bulky organosilicon-containing monomer having an ethylenically unsaturated reactive end group, (iv) from about 20 wt. % to about 60 wt. %, based on the total weight of the mixture, of a bulky siloxane monomer having an ethylenically unsaturated reactive end group, and (v) from about 0.05 wt. % to about 5 wt. %, based on the total weight of the mixture, of the ATRP initiator. The level of catalyst employed will vary within the range of 0.01 wt. % to 2 wt. % of the mixture of monomers. In some embodiments, the mixture for the ATRP procedure further includes from about 1 wt. % to about 10 wt. %, based on the total weight of the mixture, of an ultraviolet blocker having an ethylenically unsaturated reactive group.

As one skilled in the art will readily appreciate, the copolymerization product disclosed herein can contain a balance of monomeric units derived from an alkylacrylamide monomer, monomeric units derived from a hydroxyethyl acrylate monomer, monomeric units derived from a non-bulky organosilicon-containing monomer having an ethylenically unsaturated reactive end group, and monomeric units derived from the bulky siloxane monomer having an ethylenically unsaturated reactive end group.

In some embodiments, a copolymerization product can include from about 50 to about 400 repeating units of monomeric units derived from an alkylacrylamide monomer, from about 50 to about 200 repeating units of monomeric units derived from a hydroxyethyl acrylate monomer, from about 20 to about 300 repeating units of monomeric units derived from a non-bulky organosilicon-containing monomer having an ethylenically unsaturated reactive end group, and from about 1 to about 400 repeating units of monomeric units derived from the bulky siloxane monomer having an ethylenically unsaturated reactive end group.

In one or more additional non-limiting illustrative embodiments, as may be combined with one or more of the preceding paragraphs, the copolymerization product is thereafter reacted with a monomer having a reactive functionality complementary to the hydroxyl moiety of the hydroxyethyl acrylate monomer and a polymerizable ethylenically unsaturated reactive end group to obtain a silicone copolymer. The foregoing reaction will result in additional monomeric units derived from the hydroxyethyl acrylate monomer with the hydroxy moiety being reacted with the reactive functionality of the monomer such that the hydroxyethyl acrylate monomer contains an end functionalized group, i.e., a polymerizable ethylenically unsaturated reactive end group which can be complementary to an ethylenically unsaturated reactive group of a contact lens-forming comonomer as discussed below. Suitable polymerizable ethylenically unsaturated reactive end groups can be any of those discussed above.

In an illustrative embodiment, a polymerizable ethylenically unsaturated reactive end group can be one or more of an acrylate end group and a methacrylate end group.

Suitable monomer having a reactive functionality complementary to the hydroxyl moiety of the hydroxyethyl acrylate monomer and a polymerizable ethylenically unsaturated reactive end group include, for example, 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride, vinyl chloroformate and the like.

In an illustrative embodiment, the copolymerization product is present in the reaction mixture in an amount ranging from about 10 wt. % to about 90 wt. %, based on the total weight of the reaction mixture. In an illustrative embodiment, the copolymerization product is present in the reaction mixture in an amount ranging from about 50 wt. % to about 80 wt. %, based on the total weight of the reaction mixture.

In an illustrative embodiment, the monomer having a reactive functionality complementary to the hydroxyl moiety of the hydroxyethyl acrylate and a polymerizable ethylenically unsaturated reactive end group is present in the reaction mixture in an amount ranging from about 5 wt. % to about 60 wt. %, based on the total weight of the reaction mixture. In an illustrative embodiment, the monomer having a reactive functionality complementary to one of the one or more reactive functionalities of the hydrophilic monomer and a polymerizable ethylenically unsaturated reactive end group is present in the reaction mixture in an amount ranging from about 10 wt. % to about 20 wt. %, based on the total weight of the reaction mixture.

The reaction of the copolymerization product and the monomer having a reactive functionality complementary to the hydroxyl moiety of the hydroxyethyl acrylate and a polymerizable ethylenically unsaturated reactive end group can be carried out in the presence of a catalyst. Suitable catalysts include, for example, the stannous salts of carboxylic acids, such as stannous octoate, stannous oleate, stannous acetate, and stannous laurate, dialkyltin dicarboxylates, such as dibutyltin dilaurate and dibutyltin diacetate which are known in the art as urethane catalysts, as are tertiary amines and tin mercaptides. The amount of catalyst employed is generally between about 0.01 wt. % to about 5 wt. % of the mixture catalyzed.

The reaction can be carried out at a temperature of between about 60° C. to about 100° C. for about 2 hours to about 24 hours. The reaction can be carried out in the presence of a suitable solvent as discussed above.

Accordingly, in a non-limiting illustrative embodiment, a silicone copolymer disclosed herein comprises:
(i) monomeric units derived from an alkylacrylamide monomer,
(ii) monomeric units derived from a hydroxyethyl acrylate monomer,
(iii) monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group,
(iv) monomeric units derived from the bulky siloxane monomer, and
(v) monomeric units derived from a non-bulky siloxane monomer.

In some embodiments, a silicone copolymer is a silicone contact lens-forming random copolymer.

In some embodiments, a silicone copolymer disclosed herein includes:
from about 50 to about 400 repeating units of monomeric units derived from an alkylacrylamide monomer,
from about 50 to about 200 repeating units of monomeric units derived from a hydroxyethyl acrylate monomer,
from about 5 to about 20 repeating units of monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group,
from about 20 to about 300 repeating units of monomeric units derived from a non-bulky organosilicon-containing monomer having an ethylenically unsaturated reactive end group, and

from about 1 to about 400 repeating units of monomeric units derived from the bulky siloxane monomer having an ethylenically unsaturated reactive end group.

In a non-liming illustrative embodiment, a silicone copolymer can be represented by the following structure:

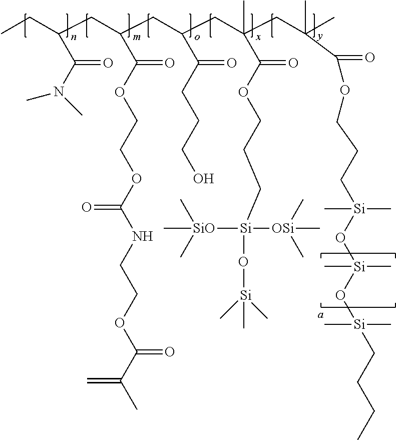

where n is about 50 to about 400, m is about 5 to about 20, o is about 50 to about 200, x is about 1 to about 400, y is about 20 to about 300 and a is about 5 to about 12.

In some embodiments, a silicone copolymer disclosed herein can have a weight average molecular weight ranging from about 10,000 to about 300,000 Daltons. The weight average molecular weight of the silicone copolymer is determined by Gel Permeation Chromatography (GPC).

In non-limiting illustrative embodiments, as may be combined with one or more of the preceding paragraphs, the silicone copolymer can further include monomeric units derived from an ultraviolet (UV) blocker having an ethylenically unsaturated reactive group to form. Suitable UV blockers having an ethylenically unsaturated reactive group can be any known UV blocker having an ethylenically unsaturated reactive group. In some embodiments, a UV blocker for use herein can include a phenolic group having a hydroxyl moiety and one or more ethylenically unsaturated reactive groups. In a non-limiting illustrative embodiment, a UV blocker comprising a phenolic group having a protected hydroxyl moiety and one or more ethylenically unsaturated reactive groups can be represented by a benzotriazole compound having the following structure:

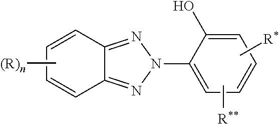

wherein each R is independently hydrogen, a halogen, an —O— group, a nitro group, a nitrile group, a substituted or unsubstituted alkoxy group, a substituted or unsubstituted hydroxyl group, a substituted or unsubstituted amine group, a substituted or unsubstituted carbonyl group, and a substituted or unsubstituted hydrocarbyl group, R* is hydrogen or a substituted or unsubstituted hydrocarbyl group, and R** is an ethylenically unsaturated reactive group.

As used herein, recitations of “substituted” group, means a group such as an alkyl group, cycloalkyl group, heterocycloalkyl group, aryl group, and/or heteroaryl group, in which at least one hydrogen atom thereof has been optionally replaced or substituted with a group that is other than hydrogen, such as, for example, halo groups (e.g., F, C₁, I, and Br), hydroxyl groups, ether groups, thiol groups, thio ether groups, carboxylic acid groups, carboxylic acid ester groups, phosphoric acid groups, phosphoric acid ester groups, sulfonic acid groups, sulfonic acid ester groups, nitro groups, cyano groups, hydrocarbyl groups (e.g., alkyl; alkenyl; alkynyl; cycloalkyl, including poly-fused-ring cycloalkyl and polycyclocalkyl; heterocycloalkyl; aryl, including hydroxyl substituted aryl, such as phenol, and including poly-fused-ring aryl; heteroaryl, including poly-fused-ring heteroaryl; and aralkyl groups), and amine groups.

As used herein, recitations of “linear or branched” groups, such as linear or branched alkyl, are herein understood to include, for example, groups that are linear, such as linear C₂ to C₃₀ alkyl groups; and groups that are appropriately branched, such as branched C₃ to C₃₀ alkyl groups.

Representative examples of halogen groups include, by way of example, C₁, I, F, and Br.

Representative examples of hydrocarbyl groups include linear or branched alkyl groups, linear or branched alkenyl groups, linear or branched alkynyl groups, cycloalkyl groups, heterocycloalkyl groups, aryl groups (including polycyclic aryl groups), heteroaryl groups (having at least one hetero atom in the aromatic ring); and aralkyl groups as defined herein.

Representative examples of alkoxy groups for use herein include, by way of example, an alkyl group as defined herein attached via oxygen linkage to the rest of the molecule, i.e., of the general formula —OR¹, wherein R¹ is an alkyl, cycloalkyl, or aromatic group as defined herein, e.g., —OCH₃, —OC₂H₅, or —OCH₅ which may be substituted or unsubstituted, and the like.

Representative examples of alkyl groups for use herein include, by way of example, a linear or branched hydrocarbon chain radical containing carbon and hydrogen atoms of from 1 to about 30 carbon atoms or from 1 to 12 carbon atoms or from 1 to 6 carbon atoms with or without unsaturation, to the rest of the molecule, e.g., methyl, ethyl, n-propyl, 1-methylethyl(isopropyl), n-butyl, n-pentyl, etc., and the like.

Representative examples of alkenyl groups for use herein include, by way of example, a straight or branched hydrocarbon chain radical containing from about 3 to about 30 carbon atoms with at least one carbon-carbon double bond such as, for example, propenyl, butenyl, pentenyl and the like.

Representative examples of alkynyl groups for use herein include, by way of example, a straight or branched hydrocarbon chain radical containing from about 3 to about 30 carbon atoms with at least one carbon-carbon triple bond such as, for example, propynyl, butynyl, pentynyl and the like.

Representative examples of cycloalkyl groups for use herein include, by way of example, a substituted or unsubstituted non-aromatic mono or multicyclic ring system of about 3 to about 30 carbon atoms or from 3 to 12 carbon atoms or from 3 to 6 carbon atoms such as, for example, cyclopropyl, cyclobutyl, cyclopentyl, cyclohexyl, perhydronapththyl, adamantyl and norbornyl groups bridged cyclic group or sprirobicyclic groups, e.g., sprio-(4, 4)-non-2-yl and the like, optionally containing one or more heteroatoms, e.g., O and N, and the like.

Representative examples of heterocyclic groups for use herein include, by way of example, a substituted or unsubstituted stable 3 to about 15 membered ring radical, containing carbon atoms and from one to five heteroatoms, e.g., nitrogen, phosphorus, oxygen, sulfur and mixtures thereof. Suitable heterocyclic ring radicals for use herein may be a monocyclic, bicyclic or tricyclic ring system, which may include fused, bridged or spiro ring systems, and the nitrogen, phosphorus, carbon, oxygen or sulfur atoms in the heterocyclic ring radical may be optionally oxidized to various oxidation states. Examples of such heterocyclic groups include, but are not limited to, azetidinyl, acridinyl, benzodioxolyl, benzodioxanyl, benzofurnyl, carbazolyl, cinnolinyl, dioxolanyl, indolizinyl, naphthyridinyl, perhydroazepinyl, phenazinyl, phenothiazinyl, phenoxazinyl, phthalazinyl, pyridyl, pteridinyl, purinyl, quinazolinyl, quinoxalinyl, quinolinyl, isoquinolinyl, tetrazoyl, imidazolyl, tetrahydroisouinolyl, piperidinyl, piperazinyl, 2-oxopiperazinyl, 2-oxopiperidinyl, 2-oxopyrrolidinyl, 2-oxoazepinyl, azepinyl, pyrrolyl, 4-piperidonyl, pyrrolidinyl, pyrazinyl, pyrimidinyl, pyridazinyl, oxazolyl, oxazolinyl, oxasolidinyl, triazolyl, indanyl, isoxazolyl, isoxasolidinyl, morpholinyl, thiazolyl, thiazolinyl, thiazolidinyl, isothiazolyl, quinuclidinyl, isothiazolidinyl, indolyl, isoindolyl, indolinyl, isoindolinyl, octahydroindolyl, octahydroisoindolyl, quinolyl, isoquinolyl, decahydroisoquinolyl, benzimidazolyl, thiadiazolyl, benzopyranyl, benzothiazolyl, benzooxazolyl, furyl, tetrahydrofurtyl, tetrahydropyranyl, thienyl, benzothienyl, thiamorpholinyl, thiamorpholinyl sulfoxide, thiamorpholinyl sulfone, dioxaphospholanyl, oxadiazolyl, chromanyl, isochromanyl and the like and mixtures thereof.

Representative examples of aryl groups for use herein include, by way of example, a substituted or unsubstituted monoaromatic or polyaromatic radical containing from about 5 to about 30 carbon atoms or from 5 to 12 carbon atoms or from 5 to 8 carbon atoms such as, for example, phenyl, naphthyl, tetrahydronapthyl, indenyl, biphenyl and the like, optionally containing one or more heteroatoms, e.g., O and N, and the like.

Representative examples of heteroaryl groups for use herein include, by way of example, a substituted or unsubstituted stable 5 to about 30 membered monoaromatic or polyaromatic radical, containing carbon atoms and from one to five heteroatoms, e.g., nitrogen, phosphorus, oxygen, sulfur and mixtures thereof.

Representative examples of fused ring polycyclic-aryl-alkyl groups and similar terms such as, fused ring polycyclic-alkyl-aryl groups, fused ring polycyclo-aryl-alkyl groups, and fused ring polycyclo-alkyl-aryl groups means a fused ring polycyclic group that includes at least one aryl ring and at least one cycloalkyl ring that are fused together to form a fused ring structure. For purposes of non-limiting illustration, examples of fused ring polycyclic-aryl-alkyl groups include, but are not limited to indenyl, 9H-flourenyl, cyclopentanaphthenyl, and indacenyl.

Representative examples of aralkyl groups as used herein, and in accordance with some embodiments, include, but are not limited to, C₆ to C₂₄ aralkyl, such as a C₆ to C₁₀ aralkyl, and means an aryl group substituted with an alkyl group.

Representative examples of amine groups for use herein include, by way of example, an amine of the general formula —R²NR³R⁴ wherein R², R³ and R⁴ are independently hydrogen or a C₁-C₃₀ hydrocarbon such as, for example, alkyl groups, aromatic groups, or cycloalkyl groups as defined herein, and the like.

The term “carbonyl group” as used herein is a divalent group of the formula-C(═O).

Representative examples of ethylenically unsaturated reactive groups for use herein include, by way of example, a (meth)acrylate-containing reactive end group, a (meth)acrylamide-containing reactive end group, an allyl-containing reactive end group, a vinyl-containing reactive end group, a vinylcarbonate-containing reactive end group, a vinylcarbamate-containing reactive end group, a styrene-containing reactive end group, an itaconate-containing reactive end group, a vinyloxy-containing reactive end group, a fumarate-containing reactive end group, a maleimide-containing reactive end group, a vinylsulfonyl reactive end group and the like.

In a non-limiting illustrative embodiment, a (meth)acrylate-containing reactive end group can be represented by the structure:

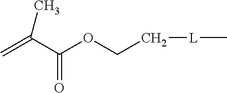

wherein L is a linking group or bond. Suitable linking groups include, for example, a heteroatom such as O, any divalent hydrocarbon radical or moiety such as independently a straight or branched, substituted or unsubstituted C₁-C₆ alkyl group, a substituted or unsubstituted C₃-C₁₂ cycloalkyl group, a substituted or unsubstituted C₄-C₁₂ cycloalkylalkyl group, a substituted or unsubstituted C₃-C₁₂ cycloalkenyl group, a substituted or unsubstituted C₆-C₁₂ aryl group, a substituted or unsubstituted C₇-C₁₂ arylalkyl group and substituted and unsubstituted ether-containing groups.

In an illustrative embodiment, R and R* are each hydrogen and R** is a (meth)acrylate-containing reactive end group.

In another illustrative embodiment, as may be combined with one or more of the preceding paragraphs, R** is positioned on the aromatic ring in the para position relative to the OH moiety.

The foregoing UV blockers for use herein are known and either commercially available from such sources as, for example, Aldrich, Polysciences, Gelest, and Melrob, or can be made by methods within the purview of one skilled in the art.

Representative examples of suitable UV blockers include 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d] [1,2,3]triazol-2-yl) phenoxy)ethyl methacrylate.

In one illustrative embodiment, suitable UV blockers include, for example, one or more compounds of the following formulae:

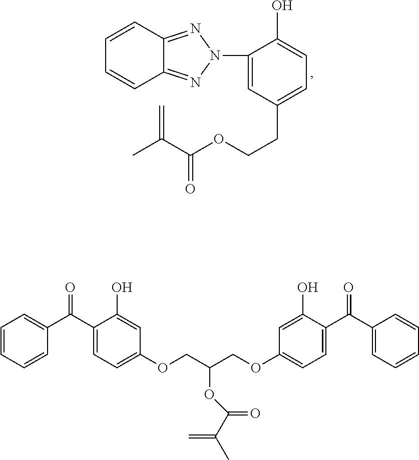 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1-[(4-benzoyl3-hydroxyphenoxy)methyl ester),

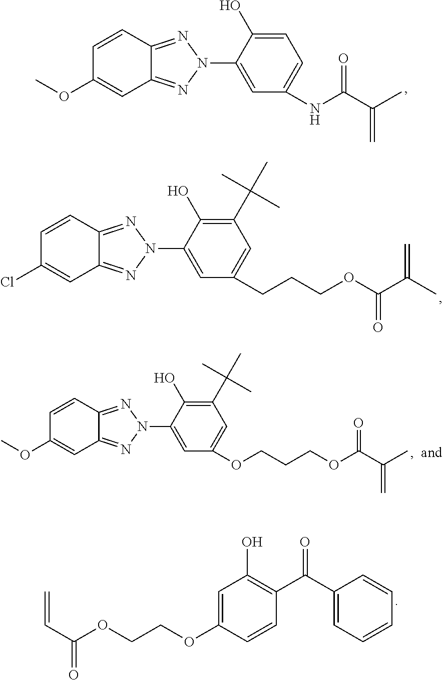

The foregoing UV blockers are merely illustrative and not intended to be limiting. Any known UV blocker comprising a phenolic group having a hydroxyl moiety and one or more ethylenically unsaturated reactive groups or later developed UV blocker comprising a phenolic group having a hydroxyl moiety and one or more ethylenically unsaturated reactive groups are contemplated for use herein.

In some embodiments, the polymerization composition can contain from about 0.1 wt. % to about 5 wt. %, based on the total weight of the polymerization composition, of a UV blocker. In some embodiments, the polymerization composition can contain from about 0.5 wt. % to about 1.5 wt. %, based on the total weight of the polymerization composition, of a UV blocker.

In non-limiting illustrative embodiments, as may be combined with one or more of the preceding paragraphs, a silicone copolymer disclosed herein further includes from about 1 to about 25 repeating units of the monomeric units derived from an ultraviolet blocker having an ethylenically unsaturated reactive group.

In non-limiting illustrative embodiments, as may be combined with one or more of the preceding paragraphs, the polymerization composition can further include one or more blue-light blockers having an ethylenically unsaturated reactive group. Many reactive blue-light absorbing compounds are known, see, e.g., the reactive blue-light absorbing compounds described in U.S. Pat. Nos. 5,470,932; 8,207,244; and 8,329,775, the contents of which are hereby incorporated by reference.

In non-limiting illustrative embodiments, a class of blue light blockers can include a phenolic group comprising a hydroxyl moiety and one or more ethylenically unsaturated reactive groups represented by an acridone compound having the following structure:

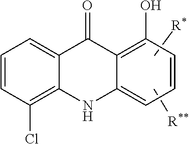

wherein R* and R** are as defined above.

In an illustrative embodiment, R* is hydrogen and R** is a (meth)acrylate-containing reactive end group as defined above.

In some embodiments, R** is positioned on the aromatic ring in the para position relative to the OH moiety.

The foregoing blue light blockers for use herein are known and either commercially available from such sources as, for example, Vishwa-Syntharo Pharma Company, or can be made by methods within the purview of one skilled in the art.

The foregoing one or more blue light blockers comprising a phenolic group having a hydroxyl moiety and one or more ethylenically unsaturated reactive groups are merely illustrative and not intended to be limiting. Any known blue light blockers comprising a phenolic group having a hydroxyl moiety and one or more ethylenically unsaturated reactive groups or later developed blue light blockers comprising a phenolic group having a hydroxyl moiety and one or more ethylenically unsaturated reactive groups are contemplated for use herein.

In some embodiments, a blue-light blocker is N-2-[3-(2′-methylphenylazo)-4-hydroxyphenyl]ethyl methacrylamide.

In some embodiments, the blue-light absorbers can be present in the polymerization composition in an amount ranging from about 0.005 to about 1 wt. %, based on the total weight of the polymerization composition. In another illustrative embodiment, the blue-light absorbers can be present in the polymerization composition in an amount ranging from about 0.01 wt. % to about 1 wt. %, based on the total weight of the polymerization composition.

In non-limiting illustrative embodiments, a red-light blocking ink binder of the present disclosure further includes a red-light blocking compound blocking from about 95% to about 98% of red-light transmission through a colored contact lens at a wavelength of from about 550 nm to about 800 nm. In an illustrative embodiment, the one or more red-light blocking compounds comprise one or more red-light blocking compounds blocking from about 95% to about 98% of red-light transmission through the colored contact lens at a wavelength of from about 550 nm to about 700 nm. In an illustrative embodiment, the one or more red-light blocking compounds comprise one or more red-light blocking compounds blocking from about 95% to about 98% of red-light transmission through the colored contact lens at a wavelength of from about 650 nm to about 680 nm.

In non-limiting illustrative embodiments, representative examples of suitable red-light blocking compounds for use herein are represented by the following compounds I-IX.

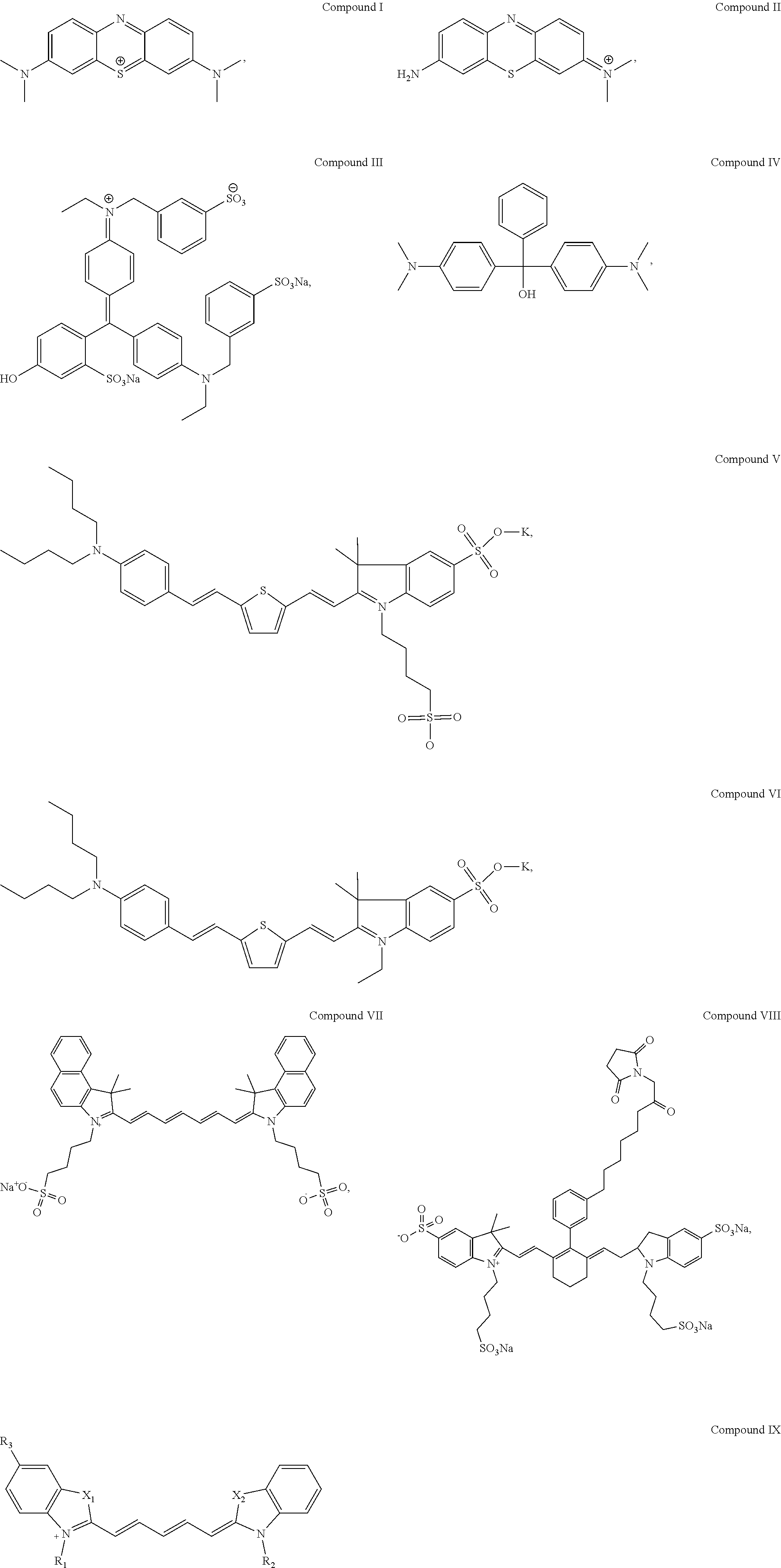

wherein X₁ and X₂ are independently CH₂ or C(CH₃)₂; R¹ and R² are independently H or (CH₂)₄SO₃Na, and R³ is H or SO₃Na.

The foregoing one or more red-light blocking compounds can be obtained by methods known in the art or are commercially available from such sources as LI-COR Biosciences, Inc.

In non-limiting illustrative embodiments, the one or more red-light blocking compounds can be red-light blocking compounds comprising sulfonate groups or vinyl sulfone groups. For example, in illustrative non-limiting embodiments, one class of red-light blocking compounds includes, for example, halotriazine compounds. Suitable halotriazine compounds are dihalotriazine compounds, such as dichlorotriazine comounds with at least one sulfonate functionality to render the compound water-soluble. The halotriazine compounds can be anionic compounds. Such dichlorotriazine compounds are described in, for example, U.S. Pat. Nos. 4,559,059 and 4,891,046, each of which is incorporated by reference herein. An example of a dichlorotriazine compound is Color Index Reactive Blue 4 which has the chemical name 2-anthracenesulfonic acid, 1-amino-4-(3-((4,6-dichloro-s-triazin-2-yl)amino)-4-sulfoanilino)-9,10-dihydro-9,10-dioxo. Monochlorotriazine compounds with at least one sulfonate functionality such as Reactive Blue #2 can also be reacted with the one or more reactive functional groups of the contact lens. In addition, water soluble compounds which can be utilized in addition to Color Index Reactive Blue 4 include the compound which is sold under the names Procion Blue MRS or Fiber Reactive Brilliant Blue MRS. This dye has the chemical name 2-anthracenesulfonic acid, 1-amino-4-(3-((4,6-dichloro-s-triazin-2-yl)amino)-4-sulfoanilino)-9,10-dih ydro-9,10-dioxo, disodium salt, or the chemical name 2-anthracenesulfonic acid, 1-amino-4-(3-((4,6-dichloro-1,3,5-triazin-2-yl)amino)-4-sulfophenyl)amino)-9,10-dihydro-9,10-dioxo, disodium salt.

In non-limiting illustrative embodiments, another class of red-light blocking compounds includes Color Index Reactive Black #5 (Remazol Black B, CAS 17095-24-8).

In non-limiting illustrative embodiments, representative structures of red-light blocking compounds for use herein include the following compounds:

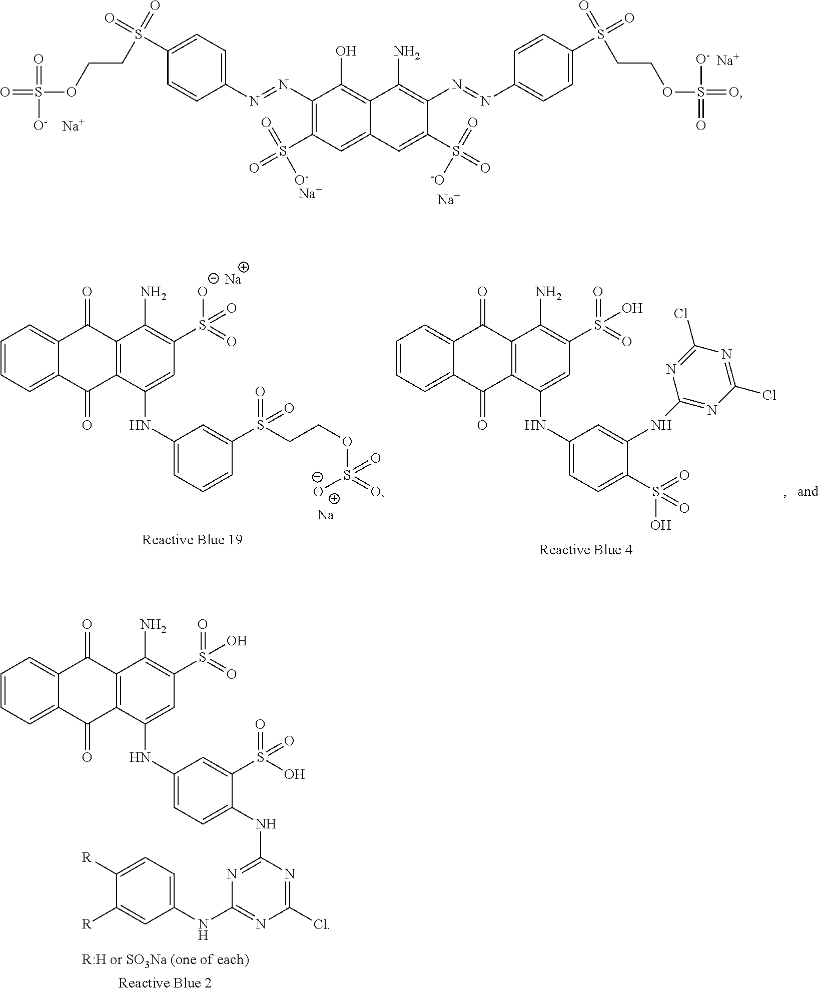

In non-limiting illustrative embodiments, the one or more red-light blocking compounds can be red-light blocking compounds having one or more methacrylate-containing reactive end groups. In one illustrative embodiment, a class of one or more red-light blocking compounds having one or more methacrylate-containing reactive end groups can be represented by those compounds having a structure of Formula IV:

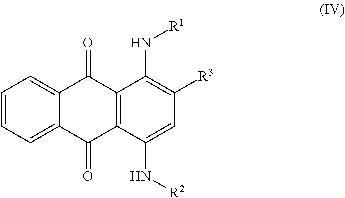

wherein R¹ and R² are hydrogen or an ethylenically unsaturated reactive end group, with at least one of R¹ and R² being an ethylenically unsaturated reactive end group; and R³ is hydrogen or a sulfonate group.

In one illustrative embodiment, another class of one or more red-light blocking compounds can be represented by those compounds having a structure of Formula V:

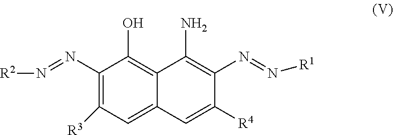

wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

In an illustrative embodiment, ethylenically unsaturated reactive end groups include by way of example, (meth)acrylate end groups, vinyl end groups, acrylamide end groups and the like. In one embodiment, an ethylenically unsaturated reactive end group is a methacrylate-containing reactive end group. Suitable methacrylate-containing reactive end groups can be those represented by the structure:

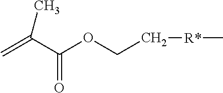

wherein R* is a linking group or bond. Suitable linking groups include, for example, any divalent hydrocarbon radical or moiety such as independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group and substituted and unsubstituted ether-containing groups. The divalent hydrocarbon radical or moiety of the linking group can optionally contain a heteroatom such as sulfur, e.g., a sulfone, in the chain.

Representative examples of alkyl groups, cycloalkyl groups and aryl groups include any of those discussed above.

Representative examples of cycloalkylalkyl groups for use herein include, by way of example, a substituted or unsubstituted cyclic ring-containing radical containing from about 4 to about 30 carbon atoms or from 3 to about 6 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like to form heterocycloalkylalkyl groups.

Representative examples of cycloalkenyl groups for use herein include, by way of example, a substituted or unsubstituted cyclic ring-containing radical containing from about 3 to about 30 carbon atoms or from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like to form heterocycloalkenyl groups.

Representative examples of arylalkyl groups for use herein include, by way of example, a substituted or unsubstituted aryl group as defined herein directly bonded to an alkyl group as defined herein, e.g.,—CH₂C₆H₅, —C₂H₄C₆H₅ and the like, wherein the aryl group can optionally contain one or more heteroatoms, e.g., O and N, and the like to form heteroarylalkyl groups.

Representative examples of ether or polyether containing groups for use herein include, by way of example, an alkyl ether, cycloalkyl ether, cycloalkylalkyl ether, cycloalkenyl ether, aryl ether, arylalkyl ether wherein the alkyl, cycloalkyl, cycloalkylalkyl, cycloalkenyl, aryl, and arylalkyl groups are as defined herein. Exemplary ether or polyether-containing groups include, by way of example, alkylene oxides, poly(alkylene oxide) s such as ethylene oxide, propylene oxide, butylene oxide, poly(ethylene oxide) s, poly(ethylene glycol) s, poly(propylene oxide) s, poly(butylene oxide) s and mixtures or copolymers thereof, an ether or polyether group of the general formula —(R¹⁴OR¹⁵) t, wherein R¹⁴ is a bond, a substituted or unsubstituted alkyl, cycloalkyl or aryl group as defined herein and R¹⁵ is a substituted or unsubstituted alkyl, cycloalkyl or aryl group as defined herein and t is at least 1, and the like.

A representative example of one or more red-light blocking compounds having one or more methacrylate-containing reactive end groups is methacrylated Reactive Black 5: a compound having the following structure prepared by the reaction of Reactive Black 5 and HEMA:

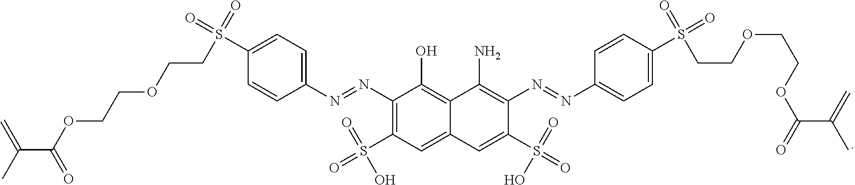 [SMILES: C=C(C)C(=O)OCCOCCS(=O)(=O)c1ccc(/N=N/c2c(S(=O)(=O)O)cc3cc(S(=O)(=O)O)c(/N=N/c4ccc(S(=O)(=O)CCOCCOC(=O)C(=C)C)cc4)c(O)c3c2N)cc1]

A representative example of one or more red-light blocking compounds having one or more methacrylate-containing reactive end groups is methacrylated Reactive Blue 19: a compound having the following structure prepared by the reaction of Reactive Blue 19 and HEMA:

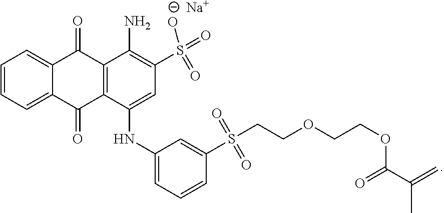 [SMILES: [Na+] ; C=C(C)C(=O)OCCOCCS(=O)(=O)c1cccc(Nc2cc(S(=O)(=O)[O-])c(N)c3c2C(=O)c2ccccc2C3=O)c1]

A representative example of one or more red-light blocking compounds having one or more methacrylate-containing reactive end groups is Reactive Blue 247: a compound having the following structure:

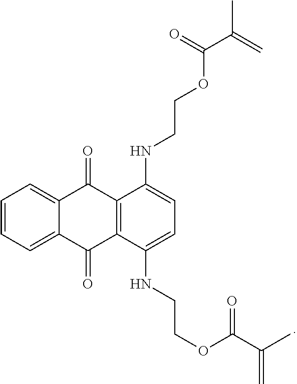 [SMILES: C=C(C)C(=O)OCCNc1ccc(NCCOC(=O)C(=C)C)c2c1C(=O)c1ccccc1C2=O]

The one or more red-light blocking compounds can be obtained by methods known in the art or are commercially available from such sources as Pharnorcia Inc. and Sigma Aldrich.

In some embodiments, a red-light blocking ink binder of the present disclosure includes a solvent in an amount of from about 10 wt. % to about 60 wt. %, or from about 20 wt. % to about 25 wt. %; a silicone copolymer in an amount of from about 5 wt. % to about 40 wt. %, or from about 10 wt. % to about 25 wt. %, and a red-light blocking compound in an amount of from about 1 wt. % to about 30 wt. %, or from about 1 wt. % to about 10 wt. %, based on the total weight of the red-light blocking ink binder. In some embodiment, the red-light blocking ink binder of the present disclosure further includes a polymerization initiator in an amount of from about 0.05 wt. % to about 5 wt. %, or from about 0.1 wt. % to about 1 wt. %, based on the total weight of the red-light blocking ink binder.

The red-light blocking ink binders of the present disclosure can be cured in a contact lens mold to form a colored pattern on a molding surface of the contact lens mold. The colored pattern comprises a red-light blocking polymer network and a red-light blocking compound therein, and characterized by having a printed ink pattern in a geometrical configuration to provide from about 95% to about 98% blocking of red-light transmission through a colored contact lens at a wavelength of from about 550 nm to about 800 nm. In some embodiments, the colored pattern comprises at least one concentric ring. In some embodiments, the colored pattern comprises at least two concentric rings. The colored pattern can be obtained by applying, to at least a portion of a molding surface of a contact lens mold, a red-light blocking ink binder and curing the red-light blocking ink binder utilizing one or more of heat (thermal cure) and/or radiation, such as ultraviolet light, visible light, or high energy radiation. The colored pattern contains a first surface in contact with the molding surface and an exposed second surface, i.e., internal to a lens-forming cavity of the contact lens mold.

A red-light blocking ink binder can be applied to a molding surface of a mold according to any printing technologies, such as, for example, pad transfer printing (or pad printing), or inkjet printing. It is understood that other types of printing technologies could also be used to print lenses and or molds. In some embodiments, the red-light blocking ink binder can be applied to a molding surface of a mold such that the colored pattern on the surface of the lens is in the form of concentric circles.

Once the red-light blocking ink binder has been applied to a molding surface of a mold, the red-light blocking ink binder can be cured. Generally, polymerization can be carried out for about 1 minutes to about 45 minutes, and may or may not be under an inert atmosphere of, for example, nitrogen or argon.

A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the polymerization initiator will be employed in the red-light blocking ink binder-forming mixture at a concentration of about 0.01 to about 5 wt. % of the total mixture.

Suitable molds for making the colored pattern and colored contact lenses as discussed below are well known to a person skilled in the art. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material. Virtually all materials known in the art for making molds can be used to make molds for making the colored pattern and colored contact lenses of the present disclosure. In some embodiments, polymeric materials include, for example, polyethylene, polypropylene, polystyrene or the like can be used. Other materials that allow UV light transmission could be used, such as quartz glass and sapphire.

In accordance with a non-limiting illustrative embodiment, colored contact lenses can be made using the colored pattern of the present disclosure. The colored pattern has good adhesion to the contact lens by being covalently attached to the lens material of the contact lens through the polymerizable ethylenically unsaturated reactive end group moiety of the monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group of a contact lens-forming material. In some embodiments, when a red-light blocking compound having one or more ethylenically unsaturated reactive end groups is used, the colored pattern has good adhesion to the contact lens by also being covalently attached to the lens material of the contact lens through any available one or more ethylenically unsaturated reactive end groups of the red-light blocking compound that are complementary to a polymerizable ethylenically unsaturated reactive end group of a contact lens-forming material. It is believed that a contact lens-forming mixture comprising one or more contact lens-forming material upon curing forms an interpenetrating polymeric network with the cured or partially cured colored pattern. The red-light blocking ink binders of the present disclosure are designed for use with non-silicone hydrogel contact lenses and silicone hydrogels of appropriate composition (e.g. low water content formulations).

In non-limiting illustrative embodiments, a colored contact lens disclosed herein can include a pupil section, an iris section having an area and circumferentially surrounding the pupil section, and a colored pattern extending across a portion of the area of the iris section in a geometrical configuration to provide from about 95% to about 98% blocking of red-light transmission through the colored contact lens at a wavelength of from about 550 nm to about 800 nm. In non-limiting illustrative embodiments, a colored contact lens disclosed herein can include a plurality of concentric rings of the red-light blocking ink binder on the contact lens. For example, in some embodiments, a colored contact lens can have at least one surface of which includes a pupil secton having a central circular area, an iris section having an area and circumferentially surrounding the pupil section and at least first and second concentric rings extending across a portion of the area of the iris section, wherein the first and second concentric rings are composed of the red-light blocking ink binder.

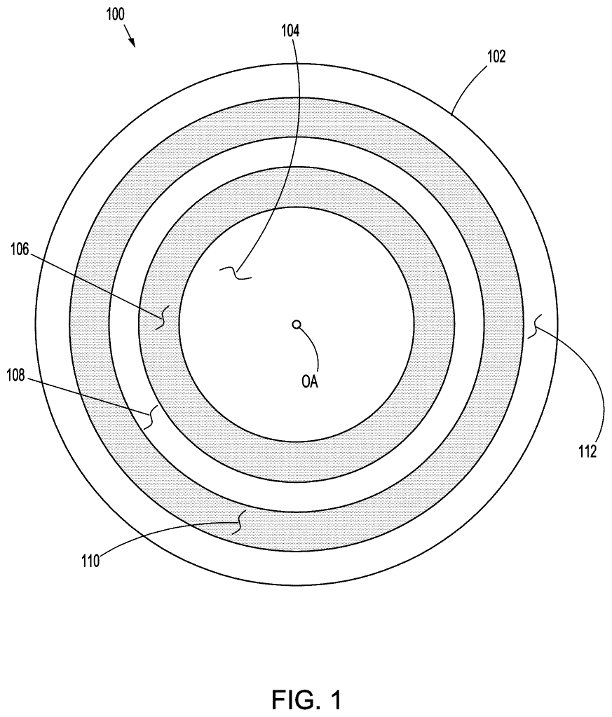

Referring now to the drawing in more detail, FIG. 1 illustrates a colored contact lens having a pupil section, a first concentric ring and a second concentric ring. It is to be understood that the colored contact lens including the pupil section, the first concentric ring and the second concentric ring is not limited to the configuration of the embodiments shown in FIG. 1, and other configurations are contemplated herein. For ease of understanding, specific examples mentioned in the following description are all illustrative and are not used to limit the protection scope of the present disclosure.

FIG. 1 illustrated a colored contact lens 100 of the present disclosure. Shown is the front, or convex, surface of colored contact lens 100. Colored contact lens 100 includes a lens body 102 having a pupil section 104 surrounded by concentric rings alternating between non-light blocking concentric rings 108 and 112 and red-light blocking concentric rings 106 and 110 in an iris section having an area and circumferentially surrounding the pupil section. Although only two red-light blocking concentric rings are shown, this is merely illustrative and any number of red-light blocking concentric rings are contemplated depending on the number and widths of the red-light blocking concentric rings. In some embodiments, the width of each of the light blocking and red-non-light blocking concentric rings can range from about 0.1 mm to about 0.25 mm. Each of the concentric rings may be the same width or a different width than one or more of the other rings. In some embodiments, the non-light blocking and red-light blocking concentric rings are spaced equidistant apart.

Pupil section 104 and non-light blocking concentric rings 108 and 112 are configured to receive visible light. For example, pupil section 104 and non-light blocking concentric rings 108 and 112 are regions for use to correct distance vision when worn by a wearer in a conventional manner. In some embodiments, pupil section 104 is circular, extending from an optical axis OA of the lens radially outward, and centered about the optical axis OA. In some embodiments, pupil section 104 can have a radius of about 0.5 mm to about 2 mm. In some embodiments, pupil section 104 is non-circular and/or does not have a center aligned with optical axis.

As mentioned, colored contact lenses can be made using the colored patten of the present disclosure. In some embodiments, the colored contact lenses disclosed herein can be obtained by dispensing a contact lens-forming mixture comprising a contact lens-forming material into the contact lens mold having the colored patten, curing the contact lens-forming mixture comprising the contact lens-forming material to form a colored contact lens, whereby the colored patten detaches from the molding surface and becomes integral with the body of the colored contact lens, and hydrating the colored contact lens.

In some embodiments, a suitable contact lens-forming material for use in the contact lens-forming mixture can include, for example, a monofunctional silicone monomer represented by a structure of Formula VI:

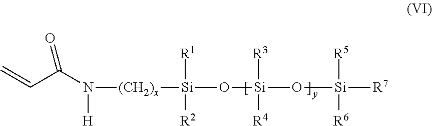

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 15.

In some embodiments, R¹, R², R³ and R⁴ of the monofunctional silicone monomer represented by a structure of Formula VI are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 8.

In some embodiments, R¹, R², R³ and R⁴ of the monofunctional silicone monomer represented by a structure of Formula VI are independently hydrogen, a C₁ to C₆ alkyl group; R⁵, R⁶ and R⁷ are independently a straight or branched C₁ to C₆ alkyl group; x is from 1 to 6; and y is from 3 to 8.

In some embodiments, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 15.

Representative examples of alkyl groups, cycloalkyl groups, cycloalkylalkyl, cycloalkenyl groups, and aryl groups include any of those discussed above.

In an illustrative embodiment, the monofunctional silicone monomer represented by the structure of Formula VI is either commercially available from such sources as ShinEtsu or can be made by methods within the purview of one skilled in the art. For example, in an illustrative embodiment, the monofunctional silicone monomer represented by the structure of Formula VI can be prepared according to the following reaction Scheme II.

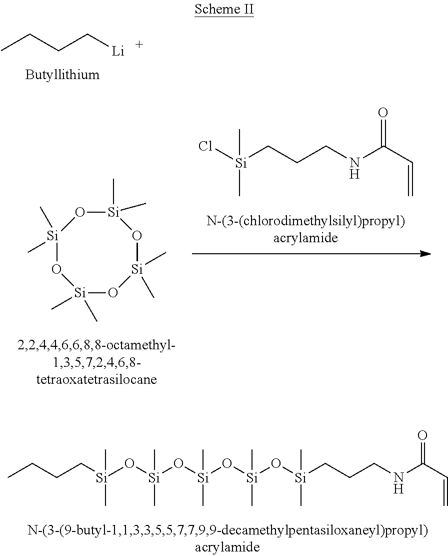

In some embodiments, the one or more monofunctional silicone monomers represented by a structure of Formula VI as disclosed herein can be present in the contact lens-forming mixture in an amount ranging from about 5 wt. % to about 40 wt. %, based on the total weight of the contact lens-forming mixture. In some embodiments, the one or more silicone monomers represented by a structure of Formula VI as disclosed herein can be present in the contact lens-forming mixture in an amount ranging from about 7 wt. % to about 15 wt. %, based on the total weight of the contact lens-forming mixture.

Suitable contact lens-forming material further includes, for example, as a class of representative contact lens-forming material, one or more non-bulky organosilicon-containing monomers as discussed above.

Representative examples of the non-bulky organosilicon-containing monomers include:

M1EDS6: a compound having the structure and available from Gelest:

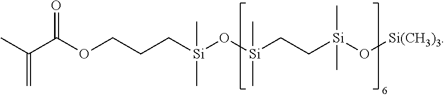

MCR-M11: a compound having the structure:

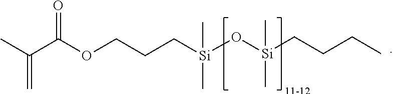

M1-MCR-C₁₂: a compound having the structure:

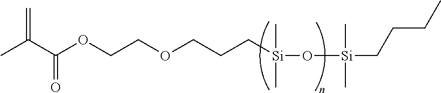

wherein n is an average of 12.

Suitable contact lens-forming material further includes, for example, as a class of representative contact lens-forming material, one or more polysiloxane prepolymers represented by a structure of Formula VII:

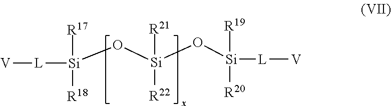

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

A hydroxyl-containing reactive functional end group for use herein is a group of the general formula-OH. Representative examples of amine-containing reactive functional end groups for use herein include, by way of example, a (meth)acrylamide-containing reactive functional end group.

Linking group L is independently a straight or branched alkyl group, cycloalkyl group, an aryl group, an ether or polyether group, and an ester group as defined herein.

A representative example of a polysiloxane prepolymer is as follows:

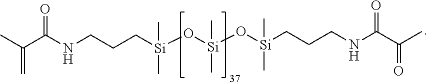

Methods for making the polysiloxane prepolymers described herein are well known and within the purview of one skilled in the art. In addition, the polysiloxane prepolymers are also commercially available from such sources as, for example, Gelest, Silar, Shin-Etsu, Momentive and Siltech.

Suitable contact lens-forming material further includes, for example, as a class of representative contact lens-forming material, one or more bulky silicone-containing monomers as discussed above.

Suitable contact lens-forming material further includes, for example, as a class of representative contact lens-forming material, one or more silicone-containing vinyl carbonate or vinyl carbamate monomers. Suitable one or more silicone-containing vinyl carbonate or vinyl carbamate monomers include, for example, 1,3-bis[4-vinyloxycarbonyloxy) but-1-yl]tetramethyl-disiloxane; 3-(trimethylsilyl) propyl vinyl carbonate; 3-(vinyloxycarbonylthio) propyl-[tris(trimethylsiloxy) silane]; 3-[tris(trimethylsiloxy) silyl]propyl vinyl carbamate; 3-[tris(trimethylsiloxy) silyl]propyl allyl carbamate; 3-[tris(trimethylsiloxy) silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Suitable contact lens-forming material further includes, for example, as a class of representative contact lens-forming material, one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacrylates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae VIII and IX:

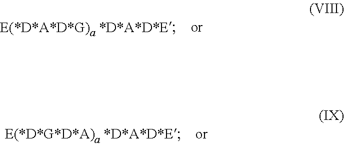

wherein:
D independently denotes an alkyl diradical, an alkyl cycloalkyl diradical, a cycloalkyl diradical, an aryl diradical or an alkylaryl diradical having 6 to about 30 carbon atoms;
G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;
a is at least 1;
A independently denotes a divalent polymeric radical of Formula X:

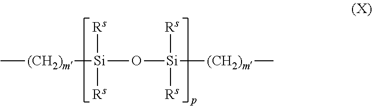

wherein each R$ independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;
each of E and E′ independently denotes a polymerizable unsaturated organic radical represented by Formula XI:

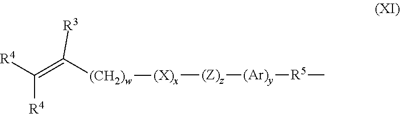

wherein: R³ is hydrogen or methyl;
R⁴ is hydrogen, an alkyl radical having 1 to 6 carbon atoms, or a —CO—Y—R⁶ radical wherein
Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

Suitable contact lens-forming material further includes, for example, as a class of representative contact lens-forming material, one or more silicone-containing urethane monomers represented by Formula XII:

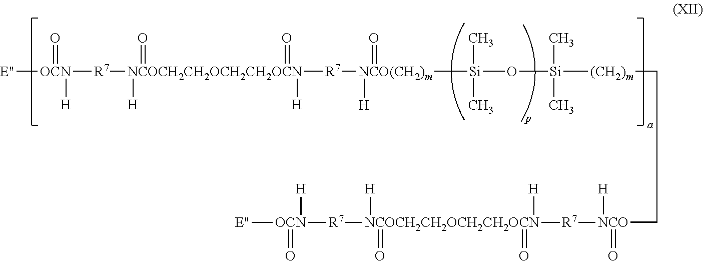

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

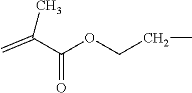

In another embodiment, a silicone hydrogel material comprises (in bulk, that is, in the contact lens-forming mixture that is copolymerized) about 5 to about 50 percent, or from about 10 to about 25, by weight of one or more silicone macromonomers, about 5 to about 75 percent, or about 30 to about 60 percent, by weight of one or more polysiloxanylalkyl (meth)acrylic monomers, and about 10 to about 50 percent, or about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the non-limiting embodiments described herein. The silane macromonomer may be a silicone-containing vinyl carbonate or vinyl carbamate or a polyurethane-polysiloxane having one or more hard-soft-hard blocks and end-capped with a hydrophilic monomer.

Suitable contact lens-forming material further includes, for example, as a class of representative contact lens-forming material, one or more monomers of Formula XIII:

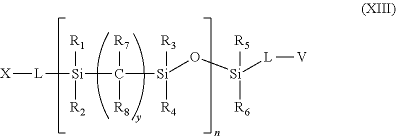

wherein X is the residue of a ring opening agent; L is the same or different and is a linking group or a bond; V is an ethylenically unsaturated polymerizable group; R¹, R², R³, R⁴, R⁵, R⁶ are independently hydrogen, an alkyl group, a haloalkyl group, a cycloalkyl group, a heterocycloalkyl group, an alkenyl group, a halo alkenyl group, or an aromatic group; R⁷ and R⁵ are independently hydrogen or an alkyl group wherein at least one of R⁷ or Ris hydrogen; y is 2-7 and n is 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linking groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated polymerizable groups are well known to those skilled in the art. Non-limiting examples of ethylenically unsaturated polymerizable groups would include acrylates, methacrylates, vinyl carbonates, O-vinyl carbamates, N-vinyl carbamates, acrylamides and methacrylamides.

Suitable contact lens-forming material further includes, for example, as a class of representative contact lens-forming material, one or more monomers of Formula XIV:

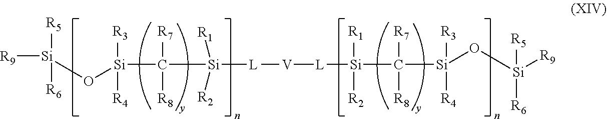

wherein L is the same or different and is a linking group or a bond; V is the same or different and is an ethylenically unsaturated polymerizable group; R₁, R₂, R₃, R₄, R₅, R₆ and Ry are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and nis 1-100.

Suitable contact lens-forming material further includes, for example, as a class of representative contact lens-forming material, one or more monomers of Formulae XV and XVII:

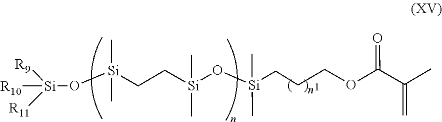

wherein R₉, R₁₀ and R₁₁ are independently hydrogen, an alkyl group, a haloalkyl group or other substituted alkyl groups; n is as defined above and n¹ is 0-10; and,

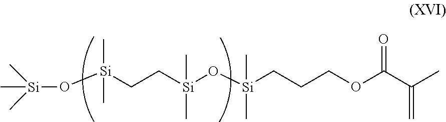

wherein n is 1 to 100, or n is 2 to 80, or n is 3 to 20, or n is 5 to 15.

Suitable contact lens-forming material further includes, for example, as a class of representative contact lens-forming material, one or more monomers of Formulas XVII-XXI:

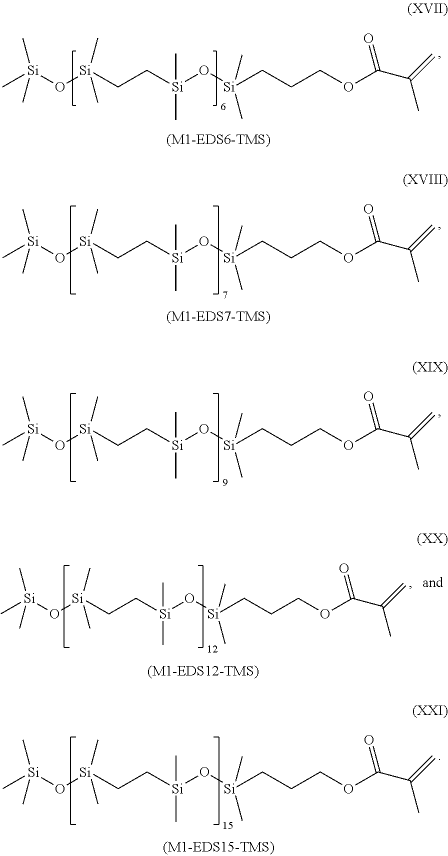

Suitable contact lens-forming material further includes, for example, as a class of representative contact lens-forming material, one or more monomers of Formulas XXII-XXIV:

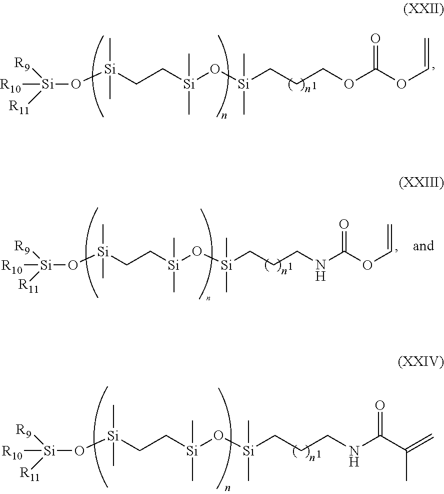

wherein R₉, R₁₀ and R₁₁ are independently hydrogen, an alkyl group, a haloalkyl group or other substituted alkyl groups and n and n¹ are as defined above.

Suitable contact lens-forming material further includes, for example, as a class of representative contact lens-forming material, one or more monomers of Formulas XXV-XXVII:

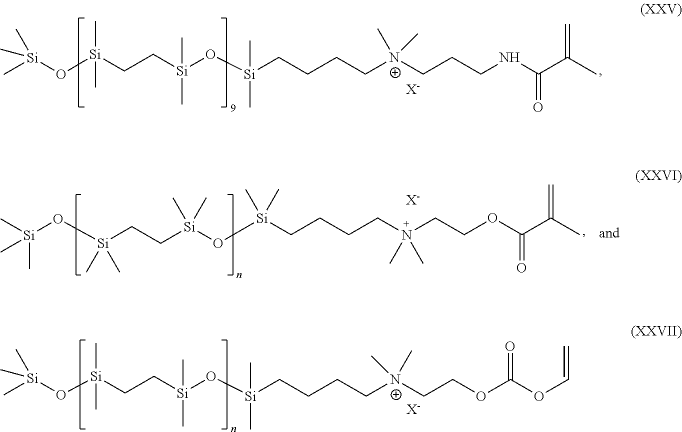

wherein n is as defined above and X is a counterion to provide an overall neutral charge.

Counterions capable of providing an overall neutral charge are well known to those of ordinary skill in the art and would include, for example, halide ions.

Suitable contact lens-forming material further includes, for example, as a class of representative contact lens-forming material, one or more monomers of Formula XXVIII:

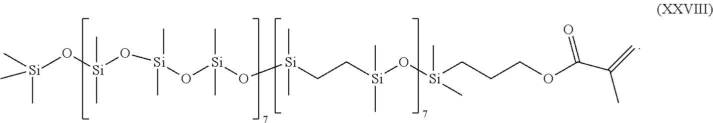

In accordance with one or more additional non-limiting illustrative embodiments, as may be combined with one or more of the preceding paragraphs, the one or more contact lens-forming material can be present in the contact lens-forming mixture in a major amount. In accordance with one or more additional non-limiting illustrative embodiments, as may be combined with one or more of the preceding paragraphs, the one or more contact lens-forming material can be present in the contact lens-forming mixture in an amount greater than about 50 wt. %, based on the total weight of the contact lens-forming mixture. In some embodiments, the one or more contact lens-forming material can be present in the contact lens-forming mixture in an amount greater than about 50 wt. % and up to 95 wt. %, based on the total weight of the contact lens-forming mixture.

The above silicone materials are merely exemplary, and other materials for use as substrates that have been disclosed in various publications and are being continuously developed for use in contact lenses and other silicone hydrogels can also be used. For example, a silicone hydrogel can be formed from at least a cationic monomer such as cationic silicone-containing monomers or cationic fluorinated silicone-containing monomers.

In non-limiting illustrative embodiments, as may be combined with one or more of the preceding paragraphs, the contact lens-forming mixture can contain one or more hydrophilic monomers. Suitable hydrophilic monomers include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include, but are not limited to, methacrylic acid, acrylic acid and the like and mixtures thereof. Representative examples of acrylamides include, but are not limited to, alkylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), glycerol methacrylate and the like and mixtures thereof.

Additional hydrophilic monomers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable silicone hydrogel-forming hydrophilic comonomers will be apparent to one skilled in the art. Mixtures of the foregoing hydrophilic comonomers can also be used in the contact lens-forming mixtures herein.

In accordance with one or more additional non-limiting illustrative embodiments, as may be combined with one or more of the preceding paragraphs, the one or more hydrophilic monomers can be present in the contact lens-forming mixture in an amount ranging from about 20 wt. % to about 60 wt. %, based on the total weight of the contact lens-forming mixture. In another illustrative embodiment, the one or more hydrophilic comonomers can be present in the contact lens-forming mixture in an amount ranging from about 25 wt. % to about 45 wt. %, based on the total weight of the contact lens-forming mixture.

In non-limiting illustrative embodiments, as may be combined with one or more of the preceding paragraphs, the contact lens-forming mixture can further contain one or more crosslinking agents. Suitable crosslinking agents for use herein are known in the art. For example, in non-limiting illustrative embodiments, suitable one or more cross-linking agents include one or more crosslinking agents containing at least two ethylenically unsaturated reactive end groups. In one embodiment, the ethylenically unsaturated reactive end groups are (meth)acrylate-containing reactive end groups. In another embodiment, the ethylenically unsaturated reactive end groups are non-(meth)acrylate reactive end groups. In one embodiment, the ethylenically unsaturated reactive end groups are a combination of one or more (meth)acrylate-containing reactive end groups and one or more non-(meth)acrylate reactive end groups.

In an illustrative embodiment, useful one or more crosslinking agents containing at least two ethylenically unsaturated reactive end groups include, for example, one or more di-, tri-or tetra(meth)acrylate-containing crosslinking agents. In an illustrative embodiment, useful one or more di-, tri- or tetra(meth)acrylate-containing crosslinking agents include, for example, alkanepolyol di-, tri- or tetra(meth)acrylate-containing crosslinking agents such as, for example, one or more alkylene glycol di(meth)acrylate crosslinking agents, one or more alkylene glycol tri (meth)acrylate crosslinking agents, one or more alkylene glycol tetra(meth)acrylate crosslinking agents, one or more alkanediol di(meth)acrylate crosslinking agents, alkanediol tri (meth)acrylate crosslinking agents, alkanediol tetra(meth)acrylate crosslinking agents, agents, one or more alkanetriol di(meth)acrylate crosslinking agents, alkanetriol tri (meth)acrylate crosslinking agents, alkanetriol tetra(meth)acrylate crosslinking agents, agents, one or more alkanetetraol di(meth)acrylate crosslinking agents, alkanetetraol tri (meth)acrylate crosslinking agents, alkanetetraol tetra(meth)acrylate crosslinking agents and the like and mixtures thereof.

In an illustrative embodiment, one or more alkylene glycol di(meth)acrylate crosslinking agents include tetraethylene glycol dimethacrylate, ethylene glycol di(meth)acrylates having up to about 10 ethylene glycol repeating units, butyleneglycol di(meth)acrylate and the like. In one embodiment, one or more alkanediol di(meth)acrylate crosslinking agents include butanediol di(meth)acrylate crosslinking agents, hexanediol di(meth)acrylate and the like. In one embodiment, one or more alkanetriol tri (meth)acrylate crosslinking agents are trimethylol propane trimethacrylate crosslinking agents. In one embodiment, one or more alkanetetraol tetra(meth)acrylate crosslinking agents are pentaerythritol tetramethacrylate crosslinking agents.

In a non-limiting illustrative embodiment, suitable crosslinking agents include, for example, ethylene glycol diacrylate, diethylene glycol diacrylate, allyl acrylate, 1,3-propanediol diacrylate, 2,3-propanediol diacrylate, 1,6-hexanediol diacrylate, 1,4-butanediol diacrylate, triethylene glycol diacrylate, cyclohexane-1,1-diyldimethanol diacrylate, 1,4-cyclohexanediol diacrylate, 1,3-adamantanediol diacrylate, 1,3-adamantanedimethyl diacrylate, 2,2-diethyl-1,3-propanediol diacrylate, 2,2-diisobutyl-1,3-propanediol diacrylate, 1,3-cyclohexanedimethyl diacrylate, 1,4-cyclohexanedimethyl diacrylate; neopentyl glycol diacrylate, tetraethyleneglycol diacrylate, polyethyleneglycol diacrylate; and their corresponding methacrylates.

In a non-limiting illustrative embodiment, suitable crosslinking agents include, for example, 1,4-butanediol diacrylate, 1,4-butanediol dimethacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, 1,3-propanediol diacrylate, 1,3-propanediol dimethacrylate, 1,6-hexanediol diacrylate, 1,6-hexanediol dimethacrylate, poly(ethylene glycol) diacrylate (Mn=700 Daltons), poly(ethylene glycol) dimethacrylate (Mn=700 Daltons), and poly(ethylene glycol) dimethacrylate (Mn=1000 Daltons).

In one embodiment, the one or more crosslinking agents containing at least two ethylenically unsaturated reactive end groups include at least one allyl-containing reactive end group and at least one (meth)acrylate-containing reactive end group. In an illustrative embodiment, the one or more crosslinking agents can be allyl methacrylate.

In non-limiting illustrative embodiments, as may be combined with one or more of the preceding paragraphs, the one or more crosslinking agents can be present in the contact lens-forming mixture in a silicone hydrogel-forming amount. In non-limiting illustrative embodiments, as may be combined with one or more of the preceding paragraphs, the one or more crosslinking agents are present in the contact lens-forming mixture in an amount of about 0.1 to about 3.0 wt. %, based on the total weight of the contact lens-forming mixture. In non-limiting illustrative embodiments, as may be combined with one or more of the preceding paragraphs, the one or more crosslinking agents are present in the contact lens-forming mixture in an amount of about 0.2 to about 1.0 wt. %, based on the total weight of the contact lens-forming mixture.

In accordance with one or more additional non-limiting illustrative embodiments, as may be combined with one or more of the preceding paragraphs, the contact lens-forming mixture can further contain one or more additional comonomers. In an illustrative embodiment, the one or more additional comonomers can include, for example, both an ethylenically unsaturated group (that permits the monomer to copolymerize with the hydrophilic comonomer) and an epoxide group (that does not react with the hydrophilic comonomer but remains to react with the copolymer). Suitable additional comonomers include, for example, glycidyl methacrylate, glycidyl acrylate, glycidyl vinylcarbonate, glycidyl vinylcarbamate, 4-vinyl-1-cyclohexene-1,2-epoxide and the like.

In non-limiting illustrative embodiments, the one or more additional comonomers can be present in the contact lens-forming mixture in an amount ranging from about 1 wt. % to about 20 wt. %, based on the total weight of the contact lens-forming mixture. In another illustrative embodiment, the one or more additional comonomers can be present in the contact lens-forming mixture in an amount ranging from about 3 wt. % to about 10 wt. %, based on the total weight of the contact lens-forming mixture.

In non-limiting illustrative embodiments, as may be combined with one or more of the preceding paragraphs, the contact lens-forming mixture can further contain a reactive (polymerizable) ultraviolet (UV) light absorber and/or a reactive blue-light absorber. Suitable reactive UV light absorbers can be any known reactive UV light absorber. In non-limiting illustrative embodiments, suitable reactive UV light absorbers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d] [1,2,3]triazol-2-yl)-4-hydroxyphenylethyl methacrylate, and 2-(3-(tert-butyl)-4-hydroxy-5-(5-methoxy-2H-benzo[d] [1,2,3]triazol-2-yl) phenoxy)ethyl methacrylate.

In one illustrative embodiment, suitable UV light absorbers include, for example, one or more compounds of the following formulas:

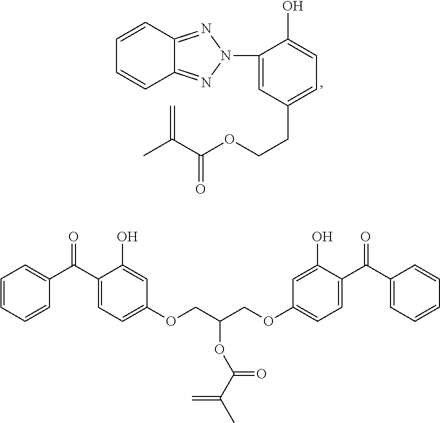 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1-[(4-benzoyl3-hydroxyphenoxy)methyl ester),

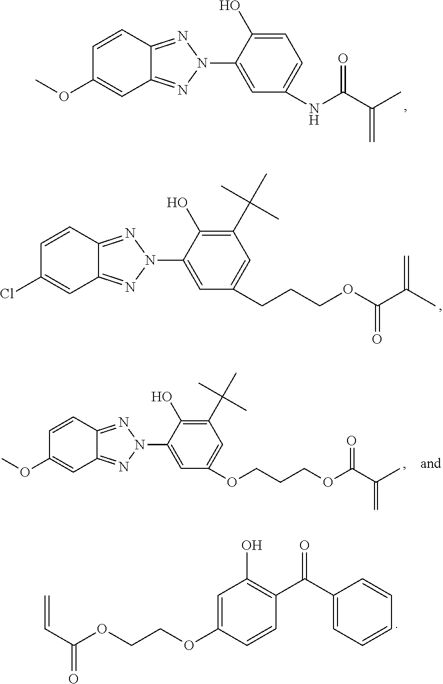

These compounds are merely illustrative and not intended to be limiting. Any known UV blocker or later developed UV blocker is contemplated for use herein.

In illustrative embodiments, the UV light absorbers can be present in the contact lens-forming mixture in an amount ranging from about 0.1 wt. % to about 5 wt. %, based on the total weight of the contact lens-forming mixture. In another illustrative embodiment, the UV light absorbers can be present in the contact lens-forming mixture in an amount ranging from about 1.5 wt. % to about 2.5 wt. %, based on the total weight of the contact lens-forming mixture. In yet another non-limiting illustrative embodiment, the UV light absorbers can be present in the contact lens-forming mixture in an amount ranging from about 1.5 wt. % to about 2 wt. %, based on the total weight of the contact lens-forming mixture.

Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference. In one embodiment, a blue-light absorbing dye is N-2-[3-(2′-methylphenylazo)-4-hydroxyphenyl]ethyl methacrylamide. In illustrative embodiments, the blue-light absorbers can be present in the contact lens-forming mixture in an amount ranging from about 0.005 wt. % to about 1 wt. %, based on the total weight of the contact lens-forming mixture. In another illustrative embodiment, the blue-light absorbers can be present in the contact lens-forming mixture in an amount ranging from about 0.01 wt. % to about 1 wt. %, based on the total weight of the contact lens-forming mixture.

In non-limiting illustrative embodiments, as may be combined with one or more of the preceding paragraphs, the contact lens-forming mixture can further contain a diluent. Suitable diluents include, for example, at least one or more boric acid esters of a C₁ to C₈ monohydric alcohol, water-soluble or partly water-soluble monohydric alcohols and mixtures thereof. In one embodiment, a diluent includes, for example, at least one or more boric acid esters of a C₁ to C₅ monohydric alcohol. Suitable boric acid esters of a C₁ to C₈ monohydric alcohol include, for example, trimethyl borate, triethyl borate, tri-n-propyl borate, triisopropyl borate, tri-n-butyl borate, and tri-tert-butyl borate. Suitable water-soluble or partly water-soluble monohydric alcohols include, for example, monohydric alcohols having from 1 to 5 carbon atoms such as methanol, ethanol, isopropyl alcohol, 1-propanol, t-butyl alcohol, 2-butyl alcohol, 2-methyl-1-propanol, t-amyl alcohol and other C₅ isomers.

In non-limiting illustrative embodiments, as may be combined with one or more of the preceding paragraphs, the contact lens-forming mixture contains about 5 wt. % to about 50 wt. % of the diluent, based on the total weight of the contact lens-forming mixture. In one embodiment, the contact lens-forming mixture contains about 15 wt. % to about 30 wt. % of the diluent, based on the total weight of the contact lens-forming mixture.

The contact lens-forming mixture may further contain, as necessary and within limits not to impair the purpose and effect of the illustrative embodiments, various additives such as an antioxidant, coloring agent, lubricant, internal wetting agent, toughening agent and the like and other constituents as are well known in the art.

In some embodiments, colored contact lenses of the present disclosure can be obtained by dispensing a contact lens-forming mixture comprising a contact lens-forming material into the contact lens mold having the colored pattern as discussed above, curing the contact lens-forming mixture comprising the contact lens-forming material and hydrating the contact lens to form the colored contact lens, whereby the colored pattern detaches from the molding surface and becomes integral with the body of the colored contact lens without any ink domain expansion.

In some embodiments, a contact lenses-forming mixture can be cast directly in the molds containing the colored pattern, e.g., polypropylene molds, from the contact lenses-forming mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the contact lenses-forming mixtures to be polymerized to a mold, and spinning the mold in a controlled manner while exposing the mixture to a radiation source such as UV light. Static casting methods involve charging the contact lens-forming mixture between two mold sections, one mold section shaped to form the anterior lens surface and the other mold section shaped to form the posterior lens surface, and curing the silicone hydrogel contact lenses-forming mixture while retained in the mold assembly to form a silicone hydrogel contact lens, for example, by free radical polymerization of the silicone hydrogel contact lenses-forming mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a contact lens-forming mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the contact lens-forming mixture to heat (thermal cure) and/or radiation, such as ultraviolet light, visible light, or high energy radiation. A polymerization initiator may be included in the contact lens-forming mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the initiator will be employed in the contact lens-forming mixture at a concentration of about 0.01 to about 5 wt. % of the total mixture.

Polymerization is generally performed in a reaction medium, such as, for example, a solution or dispersion using a solvent, e.g., water or an alkanol containing from 1 to 4 carbon atoms such as methanol, ethanol or propan-2-ol. Alternatively, a mixture of any of the above solvents may be used.

Generally, polymerization can be carried out for about 15 minutes to about 72 hours, and under an inert atmosphere of, for example, nitrogen or argon. If desired, the resulting polymerization product can be dried under vacuum, e.g., for about 5 to about 72 hours, or left in an aqueous solution prior to use.

Polymerization of the contact lens-forming mixtures will yield a colored polymer, that when hydrated, forms a colored contact lens with relatively little to no ink domain expansion, i.e., the ink pattern of colored pattern remains the same. In non-limiting illustrative embodiments, as may be combined with one or more of the preceding paragraphs, a contact lens as disclosed herein can be a high water content silicone hydrogel having an equilibrium water content of at least about 50 wt. %. In another illustrative embodiment, the silicone hydrogels disclosed herein can be high water content silicone hydrogels having an equilibrium water content of at least about 60 wt. %. In another illustrative embodiment, the silicone hydrogels disclosed herein can be high water content silicone hydrogels having an equilibrium water content of at least about 70 wt. %. In another illustrative embodiment, the silicone hydrogels disclosed herein can be high water content silicone hydrogels having an equilibrium water content of from about 50 wt. % to about 80 wt. %.

In a non-limiting illustrative embodiment, a colored contact lens disclosed herein can have an oxygen permeability of at least about 80 Barrers. In some embodiments, a contact lens disclosed herein can have an oxygen permeability of from about 90 Barrers to about 130 Barrers.

In a non-limiting illustrative embodiment, a contact lens disclosed herein can have an equilibrium water content of at least about 20 wt. %. In another illustrative embodiment, a contact lens can have an equilibrium water content of from about 20 wt. % to about 60 wt. %.

The colored contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative of the invention. The examples should not be read as limiting the scope of the invention as defined in the claims.

In the examples, the following abbreviations are used.
DMA: N,N-dimethylacrylamide.
NVP: N-vinyl-2-pyrrolidone.
HEMA: 2-hydroxyethyl methacrylate.
EGDMA: Ethylene glycol dimethacrylate.
IMVT: 1,4-bis(4-(2-methacryloxyethyl)phenylamino) anthraquinone.
UV416: 2-(4-Benzoyl-3-hydroxyphenoxy)ethyl acrylate.
TrisMA: tris(trimethylsiloxy) silylpropyl methacrylate.
Irgacure 819 (photoinitiator): a compound having the structure:

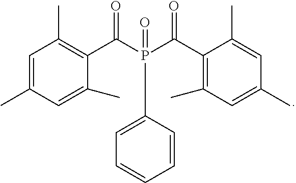

MIEDS6: A compound having the following structure and available from Gelest:

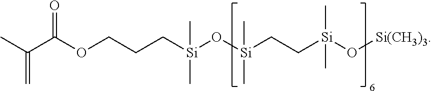

Ma2D37: A compound having the structure:

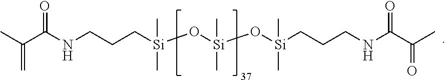

Si—CO is TRIS-MCRM11-DMA-HEA-SA which is a copolymer represented by the following structure:

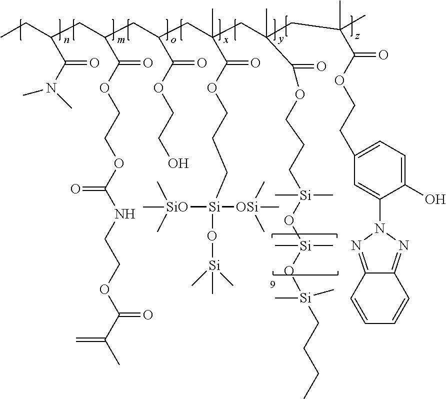

where n is 126, m is 8, o is 73, x is 57, y is 33 and z is 3.

HEA: Hydroxyethyl acrylate.

Reactive Blue 2: (2-anthracenesulfonic acid, 1-amino-4-[[4-[[4-chloro-6-[[3 (or 4)-sulfophenyl]amino]-1,3,5-triazin-2-yl]amino]-3-sulfophenyl]amino]-9,10-dihydro-9,10-dioxo-).

### EXAMPLE 1

A red-light blocking ink binder was prepared using the reaction components listed in Table 1 below, as amounts per weight percent.

TABLE 1

| Component | Wt. % |
|---|---|
| Si—CO | 40 |
| Ethyl-l-lactate | 30 |
| Cyclopentanone | 18 |
| Reactive Blue 2 | 10 |
| Irgacure 819 | 2 |

Preparation of red-light blocking ink binder.

The red-light blocking ink binder was prepared by forming a mixture containing 40 g of Si-CO with 30 g of ethyl-1-lactate, 18 g of cyclopentanone, and 34 g of milling beads. The mixture was then processed in a speed mixer for 10 minutes at 2500 rpm. After this initial mixing, the co-polymer's dissolution was checked. If it was not fully dissolved, the mixture was blended for an additional 5 minutes at the same speed. Once the co-polymer was completely dissolved, 10 g of Reactive Blue 2 and 2 g of Irgacure 819 were added. This mixture was then subjected to another round of speed mixing: first for 10 minutes at 1000 rpm, followed by 10 minutes at 800 rpm. The milling beads were filtered out.

Preparation of colored concentric rings.

The red-light blocking ink binder was poured into the loading cup of a Teca Printer and then printed onto polypropylene molds. After printing, the printed molds were cured under 3 mW/cm² intensity UV or 420 nm LED light for 10 minutes. The print pattern on the printed molds was in the form of concentric rings.

### EXAMPLE 2

A colored silicone hydrogel contact lens was obtained from a silicone hydrogel contact lens-forming mixture made by mixing the following components, listed in Table 2 at amounts per weight.

TABLE 2

| Formulation | |
|---|---|
| Ma2D37 | 6.00 |
| M1EDS6 | 15.00 |
| TRIS-MA | 28.00 |
| DMA | 7.00 |
| HEMA | 1.00 |
| NVP | 34.00 |
| UV-416 | 1.00 |
| EGDMA | 0.1 |
| IMVT | 0.02 |
| Irgacure 819 | 0.50 |
| Hexanol | 7.38 |

The silicone hydrogel contact lens-forming mixture was cast into a colored silicone hydrogel contact lens by introducing the silicone hydrogel contact lens-forming mixture to the mold assembly containing the colored concentric rings of Example 1. Prior to introducing the silicone hydrogel contact lens-forming mixture to the mold assembly, the molds were put in a N2 chamber and waited for 30 minutes so that all surface adsorbed O2 gets removed from the molds. Next, the silicone hydrogel contact lens-forming mixture were introduced to the mold assembly. After waiting for 1 minute, lenses were cured at 4.5 mW/Cm₂ UV/420 nm for 28 minutes. The colored silicone hydrogel contact lens was released from the mold assembly.

The colored silicone hydrogel contact lens was then put in a phosphate buffer solution for hydration. The colored silicon hydrogel contact lens was kept in the phosphate buffer solution for 4 hours for a complete hydration.

Following hydrating the colored silicone hydrogel contact lens, the ink pattern of the colored silicone hydrogel contact lens did not expand or came off from the lens after hydration, and the lens had good resolution.

According to an aspect of the present disclosure, a red-light blocking ink binder comprises:
(a) a solvent,
(b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, with (ii) a monomer having a reactive functionality complementary to the hydroxyl moiety of the hydroxyethyl acrylate monomer and a polymerizable ethylenically unsaturated reactive end group, and
(c) a red-light blocking compound blocking from about 95% to about 98% of red-light transmission through a colored contact lens at a wavelength of from about 550 nanometers (nm) to about 800 nm.

In non-limiting illustrative embodiments, as may be combined with one or more of the preceding paragraphs, the alkylacrylamide monomer is N,N-dimethylacrylamide.

In non-limiting illustrative embodiments, as may be combined with one or more of the preceding paragraphs, the non-bulky organosilicon-containing monomer is represented by the following structure:

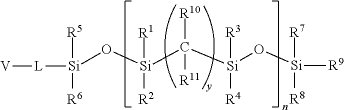

wherein V is an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

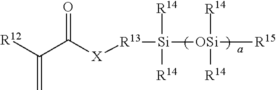

wherein R¹² is H or methyl; X is O or NR¹⁶; wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

In non-limiting illustrative embodiments, as may be combined with one or more of the preceding paragraphs, the bulky siloxane monomer is selected from the group consisting of a bulky polysiloxanylalkyl (meth)acrylic monomer, a bulky polysiloxanylalkyl carbamate monomer and mixtures thereof.

In non-limiting illustrative embodiments, as may be combined with one or more of the preceding paragraphs, the bulky siloxane monomer is represented by the following structure:

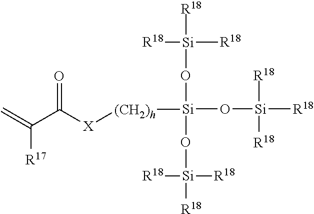

wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure:

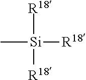

wherein each R¹⁸′ independently denotes a lower alkyl radical or a phenyl radical; and h is 1 to 10; or the following structure:

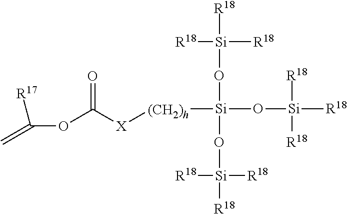

wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

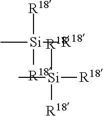

wherein each R¹⁸′ independently denotes a lower alkyl radical or a phenyl radical; and h is 1 to 10.

In non-limiting illustrative embodiments, as may be combined with one or more of the preceding paragraphs, the monomer having a reactive functionality complementary to the hydroxyl moiety of the hydroxyethyl acrylate monomer and a polymerizable ethylenically unsaturated reactive end group is selected from the group consisting of 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and vinyl chloroformate.

In non-limiting illustrative embodiments, as may be combined with one or more of the preceding paragraphs, the silicone copolymer comprises:
about 50 to about 400 repeating units of monomeric units derived from an alkylacrylamide monomer,
about 50 to about 200 repeating units of monomeric units derived from a hydroxyethyl acrylate monomer,
about 5 to about 20 repeating units of monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group,
about 20 to about 300 repeating units of monomeric units derived from a non-bulky organosilicon-containing monomer having an ethylenically unsaturated reactive end group, and
about 1 to about 400 repeating units of monomeric units derived from the bulky siloxane monomer having an ethylenically unsaturated reactive end group.

In non-limiting illustrative embodiments, as may be combined with one or more of the preceding paragraphs, the silicone copolymer has a weight average molecular weight ranging from about 10,000 to about 300,000 Daltons.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 550 nm to about 700 nm.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 650 nm to about 680 nm.

In non-limiting illustrative embodiments, as may be combined with one or more of the preceding paragraphs, the red-light blocking compound is represented by one of the following compounds:

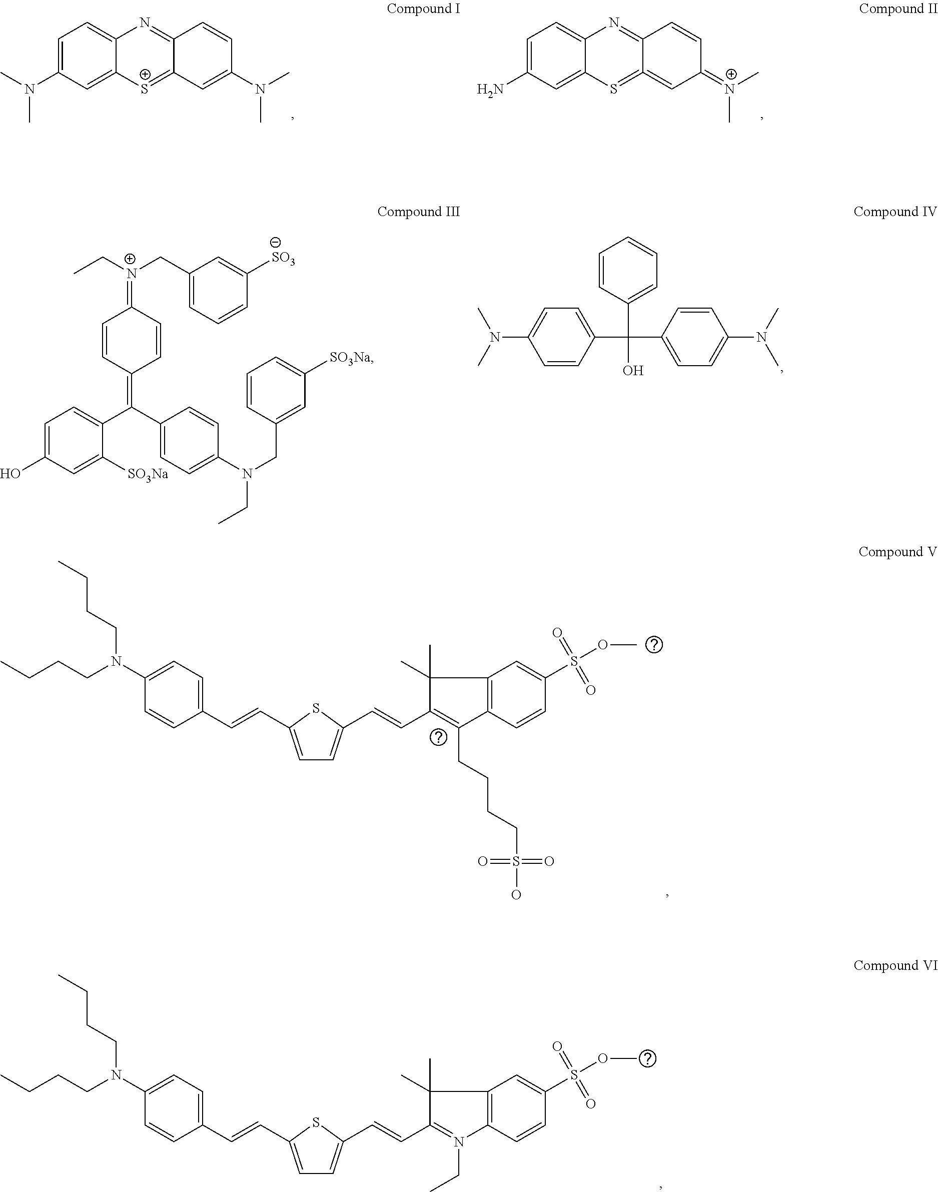

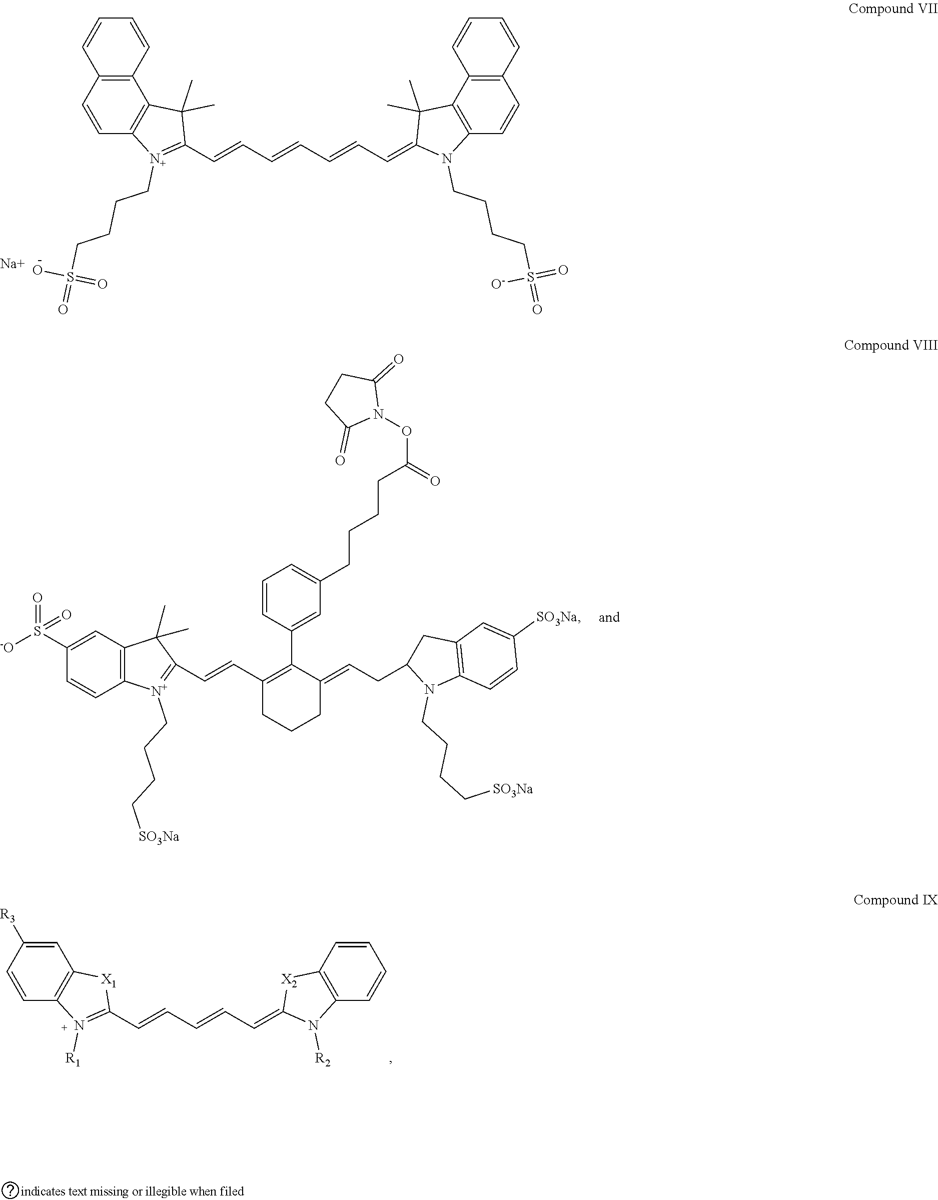

wherein X₁ and X₂ are independently CH₂ or C(CH₃)₂; R¹ and R² are independently H or (CH₂)₄SO₃Na, and R³ is H or SO₃Na.

In non-limiting illustrative embodiments, as may be combined with one or more of the preceding paragraphs, the red-light blocking compound is represented by one of the following compounds:

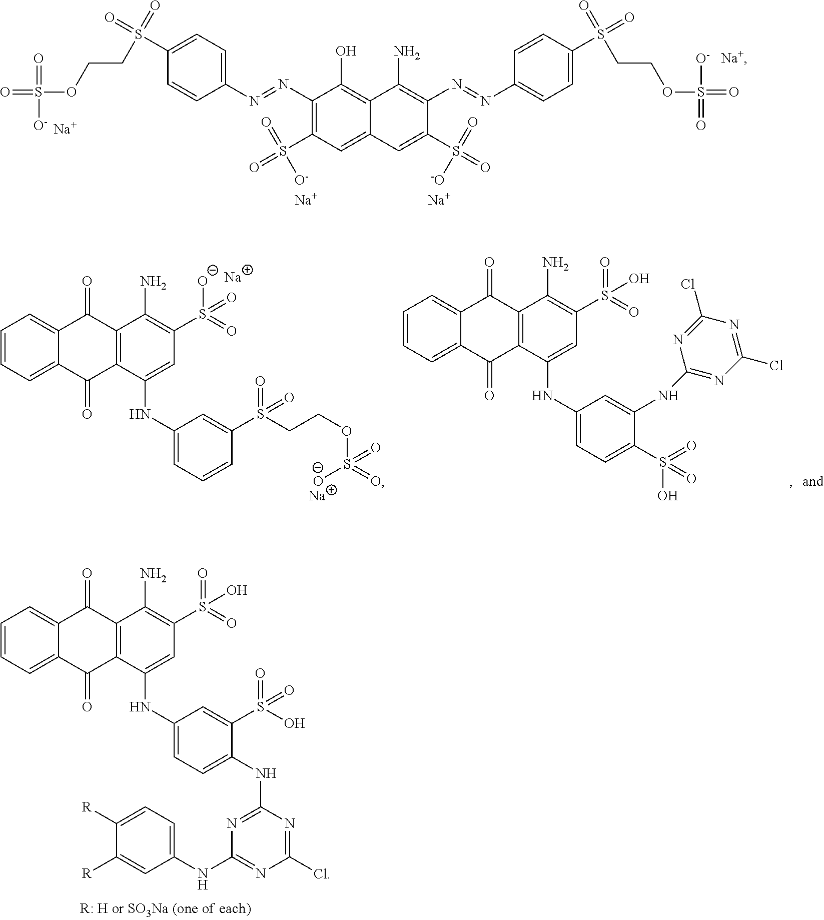

In non-limiting illustrative embodiments, as may be combined with one or more of the preceding paragraphs, the red-light blocking compound is represented by a structure as follows:

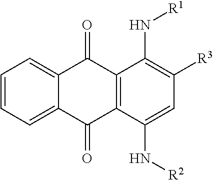

wherein R¹ and R² are hydrogen or an ethylenically unsaturated reactive end group, with at least one of R¹ and R² being an ethylenically unsaturated reactive end group; and R³ is hydrogen or a sulfonate group.

In non-limiting illustrative embodiments, as may be combined with one or more of the preceding paragraphs, the red-light blocking compound is represented by a structure as follows:

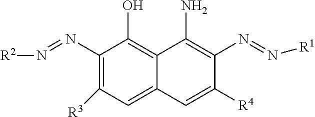

wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

In non-limiting illustrative embodiments, as may be combined with one or more of the preceding paragraphs, the ethylenically unsaturated reactive end group is a methacrylate-containing reactive end group represented by a structure as follows:

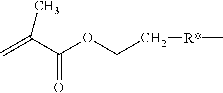

wherein R* is a linking group or bond, wherein the linking group is a divalent hydrocarbon radical.

According to another aspect of the present disclosure a colored contact lens comprises:
a pupil section,
an iris section having an area and circumferentially surrounding the pupil section, and a colored pattern extending across a portion of the area of the iris section in a
geometrical configuration to provide from about 95% to about 98% blocking of red-light transmission through the colored contact lens at a wavelength of from about 550 nanometers (nm) to about 800 nm, the colored pattern comprising a polymerization product of a red-light blocking ink binder comprising (a) a solvent, (b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, and (c) a red-light blocking compound blocking from about 95% to about 98% of red-light transmission through the colored contact lens at a wavelength of from about 550 nm to about 800 nm, with (ii) a monomer having a reactive functionality complementary to the hydroxyl moiety of the hydroxyethyl acrylate monomer and a polymerizable ethylenically unsaturated reactive end group, and (c) a red-light blocking compound blocking from about 95% to about 98% of red-light transmission through the colored contact lens at the wavelength of from about 550 nm to about 800 nm through a colored contact lens.

In non-limiting illustrative embodiments, as may be combined with one or more of the preceding paragraphs, the alkylacrylamide monomer is N,N-dimethylacrylamide.

In non-limiting illustrative embodiments, as may be combined with one or more of the preceding paragraphs, the non-bulky organosilicon-containing monomer is represented by the following structure:

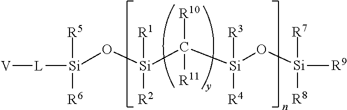

wherein V is an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

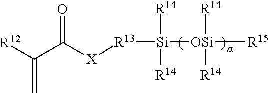

wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

In non-limiting illustrative embodiments, as may be combined with one or more of the preceding paragraphs, the bulky siloxane monomer is selected from the group consisting of a bulky polysiloxanylalkyl (meth)acrylic monomer, a bulky polysiloxanylalkyl carbamate monomer and mixtures thereof.

In non-limiting illustrative embodiments, as may be combined with one or more of the preceding paragraphs, the bulky siloxane monomer is represented by the following structure:

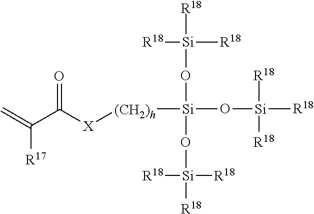

wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure:

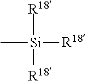

wherein each R¹⁸′ independently denotes a lower alkyl radical or a phenyl radical; and h is 1 to 10; or the following structure:

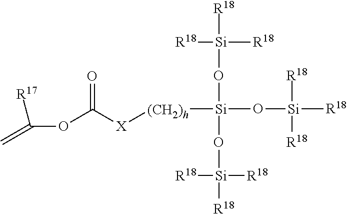

wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

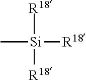

wherein each R¹⁸′ independently denotes a lower alkyl radical or a phenyl radical; and h is 1 to 10.

In non-limiting illustrative embodiments, as may be combined with one or more of the preceding paragraphs, the monomer having a reactive functionality complementary to the hydroxyl moiety of the hydroxyethyl acrylate monomer and a polymerizable ethylenically unsaturated reactive end group is selected from the group consisting of 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and vinyl chloroformate.

In non-limiting illustrative embodiments, as may be combined with one or more of the preceding paragraphs, the silicone copolymer comprises:
about 50 to about 400 repeating units of monomeric units derived from an alkylacrylamide monomer,
about 50 to about 200 repeating units of monomeric units derived from a hydroxyethyl acrylate monomer,
about 5 to about 20 repeating units of monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group,
about 20 to about 300 repeating units of monomeric units derived from a non-bulky organosilicon-containing monomer having an ethylenically unsaturated reactive end group, and
about 1 to about 400 repeating units of monomeric units derived from the bulky siloxane monomer having an ethylenically unsaturated reactive end group.

In non-limiting illustrative embodiments, as may be combined with one or more of the preceding paragraphs, the silicone copolymer has a weight average molecular weight ranging from about 10,000 to about 300,000 Daltons.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 550 nm to about 700 nm.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 650 nm to about 680 nm.

In non-limiting illustrative embodiments, as may be combined with one or more of the preceding paragraphs, the red-light blocking compound is represented by one of the following compounds:

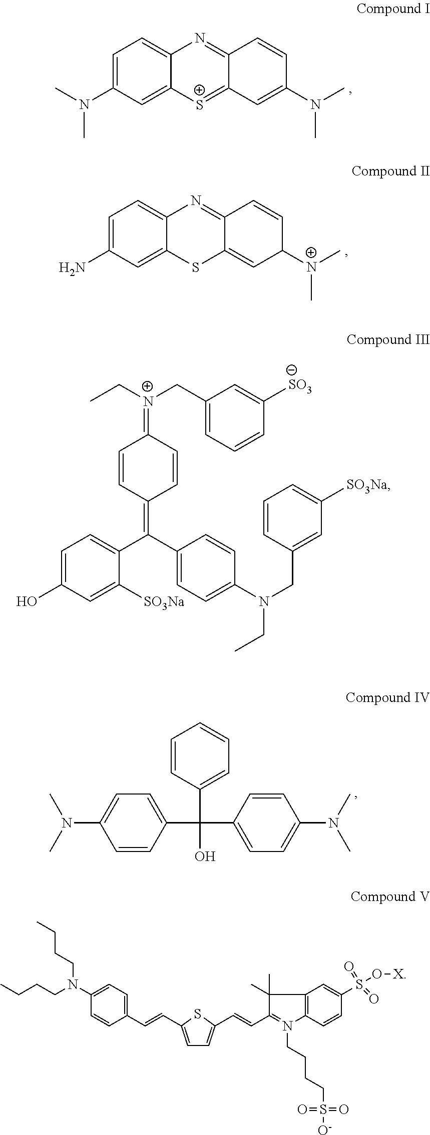

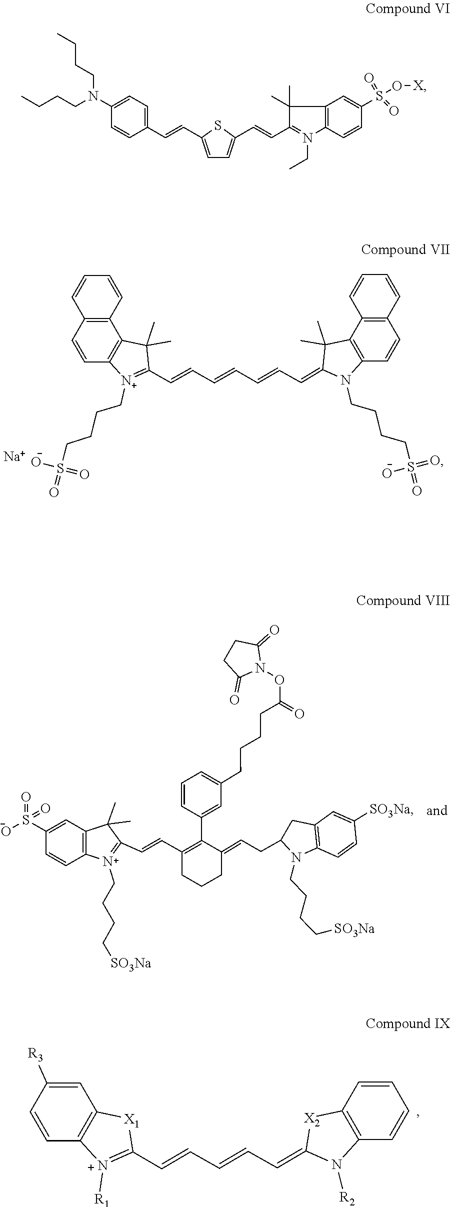

wherein X₁ and X₂ are independently CH₂ or C(CH₃)₂; R¹ and R² are independently H or (CH₂)₄SO₃Na, and R³ is H or SO₃Na.

In non-limiting illustrative embodiments, as may be combined with one or more of the preceding paragraphs, the red-light blocking compound is represented by one of the following compounds:

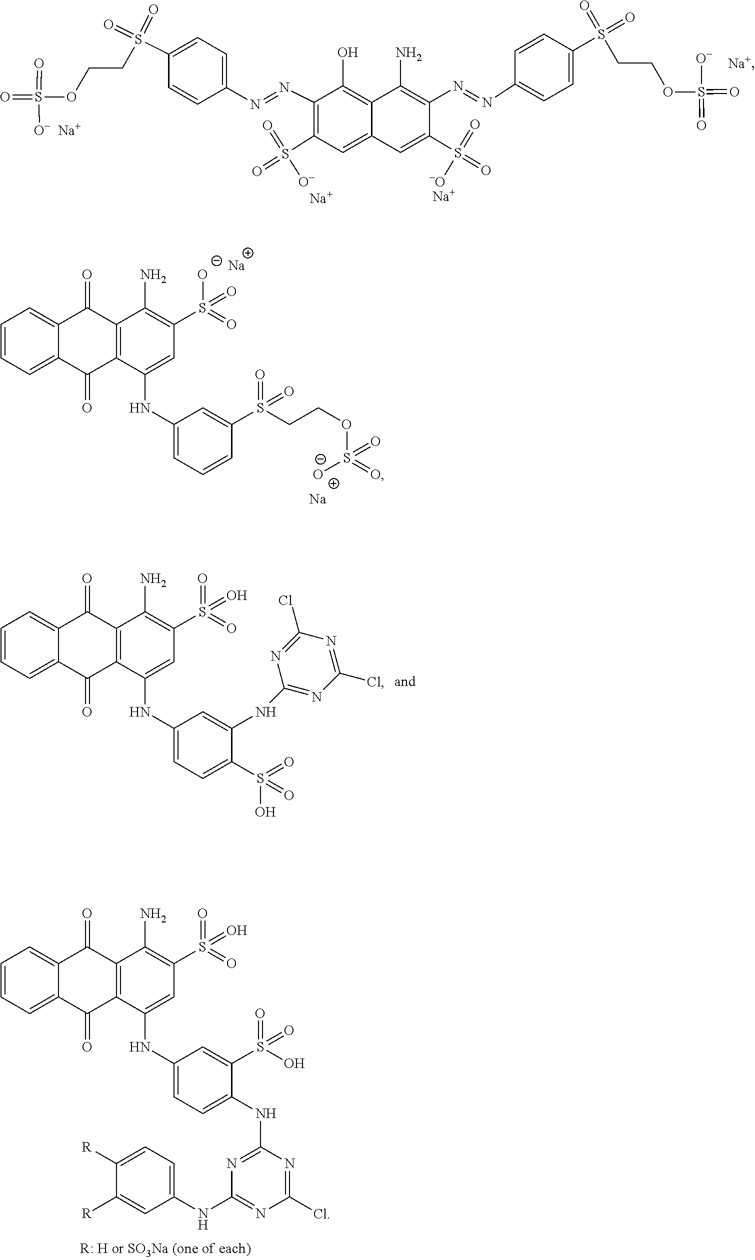

In non-limiting illustrative embodiments, as may be combined with one or more of the preceding paragraphs, the red-light blocking compound is represented by a structure as follows:

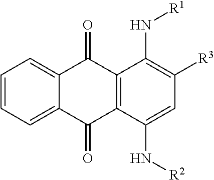

wherein R¹ and R² are hydrogen or an ethylenically unsaturated reactive end group, with at least one of R¹ and R² being an ethylenically unsaturated reactive end group; and R³ is hydrogen or a sulfonate group.

In non-limiting illustrative embodiments, as may be combined with one or more of the preceding paragraphs, the red-light blocking compound is represented by a structure as follows:

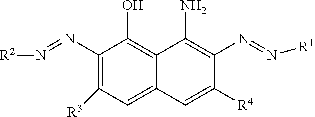

wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

In non-limiting illustrative embodiments, as may be combined with one or more of the preceding paragraphs, the ethylenically unsaturated reactive end group is a methacrylate-containing reactive end group represented by a structure:

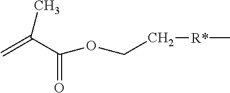

wherein R* is a linking group or bond, wherein the linking group is a divalent hydrocarbon radical.

In non-limiting illustrative embodiments, as may be combined with one or more of the preceding paragraphs, wherein the colored contact lens is a colored silicone contact lens.

In non-limiting illustrative embodiments, as may be combined with one or more of the preceding paragraphs, the colored contact lens is a colored non-silicone hydrogel.

In non-limiting illustrative embodiments, as may be combined with one or more of the preceding paragraphs, the colored pattern comprises a geometrical configuration comprising one or more red-light blocking concentric rings.

In non-limiting illustrative embodiments, as may be combined with one or more of the preceding paragraphs, the colored pattern comprises one or more red-light blocking concentric rings and one or more non-light blocking concentric rings surrounding the pupil section.

According to yet another aspect of the present disclosure, a method comprises:
(a) applying, to at least a portion of a molding surface of a contact lens mold, a red-light blocking ink binder comprising (i) a solvent, (ii) a silicone copolymer comprising a reaction product of (1) a copolymerization product of a polymerization composition comprising (i1) an alkylacrylamide monomer, (12) a hydroxyethyl acrylate monomer, (i3) a non-bulky organosilicon-containing monomer having an ethylenically unsaturated reactive end group, and (14) a bulky siloxane monomer having an ethylenically unsaturated reactive end group, with (2) a monomer having a reactive functionality complementary to the hydroxyl moiety of the hydroxyethyl acrylate monomer and a polymerizable ethylenically unsaturated reactive end group, and (iii) a red-light blocking compound blocking from about 95% to about 98% of red-light transmission through a colored contact lens at a wavelength of from about 550 nanometers (nm) to about 800 nm, and
(b) curing the red-light blocking ink binder to form a colored pattern which comprises a red-light blocking polymer network comprising the red-light blocking compound in the polymer network, wherein the colored pattern contains a first surface in contact with the molding surface and an exposed second surface.

In non-limiting illustrative embodiments, as may be combined with one or more of the preceding paragraphs, the alkylacrylamide monomer is N,N-dimethylacrylamide.

In non-limiting illustrative embodiments, as may be combined with one or more of the preceding paragraphs, the non-bulky organosilicon-containing monomer is represented by the following structure:

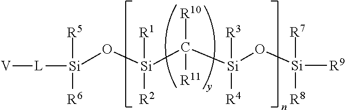

wherein V is an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

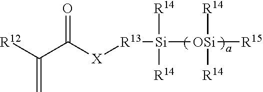

wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

In non-limiting illustrative embodiments, as may be combined with one or more of the preceding paragraphs, the bulky siloxane monomer is selected from the group consisting of a bulky polysiloxanylalkyl (meth)acrylic monomer, a bulky polysiloxanylalkyl carbamate monomer and mixtures thereof.

In non-limiting illustrative embodiments, as may be combined with one or more of the preceding paragraphs, the bulky siloxane monomer is represented by the following structure:

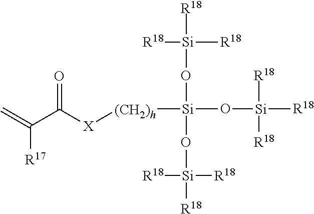

wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure:

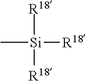

wherein each R¹⁸′ independently denotes a lower alkyl radical or a phenyl radical; and h is 1 to 10; or the following structure:

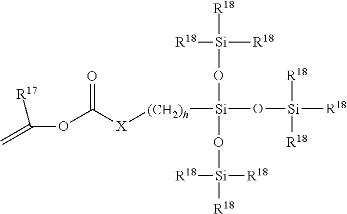

wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

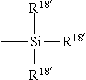

wherein each R¹⁸′ independently denotes a lower alkyl radical or a phenyl radical; and h is 1 to 10.

In non-limiting illustrative embodiments, as may be combined with one or more of the preceding paragraphs, the monomer having a reactive functionality complementary to the hydroxyl moiety of the hydroxyethyl acrylate monomer and a polymerizable ethylenically unsaturated reactive end group is selected from the group consisting of 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and vinyl chloroformate.

In non-limiting illustrative embodiments, as may be combined with one or more of the preceding paragraphs, the silicone copolymer comprises:
about 50 to about 400 repeating units of monomeric units derived from an alkylacrylamide monomer,
about 50 to about 200 repeating units of monomeric units derived from a hydroxyethyl acrylate monomer,
about 5 to about 20 repeating units of monomeric units derived from a hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group,
about 20 to about 300 repeating units of monomeric units derived from a non-bulky organosilicon-containing monomer having an ethylenically unsaturated reactive end group, and
about 1 to about 400 repeating units of monomeric units derived from the bulky siloxane monomer having an ethylenically unsaturated reactive end group.

In non-limiting illustrative embodiments, as may be combined with one or more of the preceding paragraphs, the silicone copolymer has a weight average molecular weight ranging from about 10,000 to about 300,000 Daltons.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 650 nm to about 680 nm.

In non-limiting illustrative embodiments, as may be combined with one or more of the preceding paragraphs, the red-light blocking compound comprises a red-light blocking compound blocking from about 95% to about 98% of red-light transmission through the colored contact lens at a wavelength of from about 550 nm to about 800 nm.

In non-limiting illustrative embodiments, as may be combined with one or more of the preceding paragraphs, the red-light blocking compound is represented by one of the following compounds:

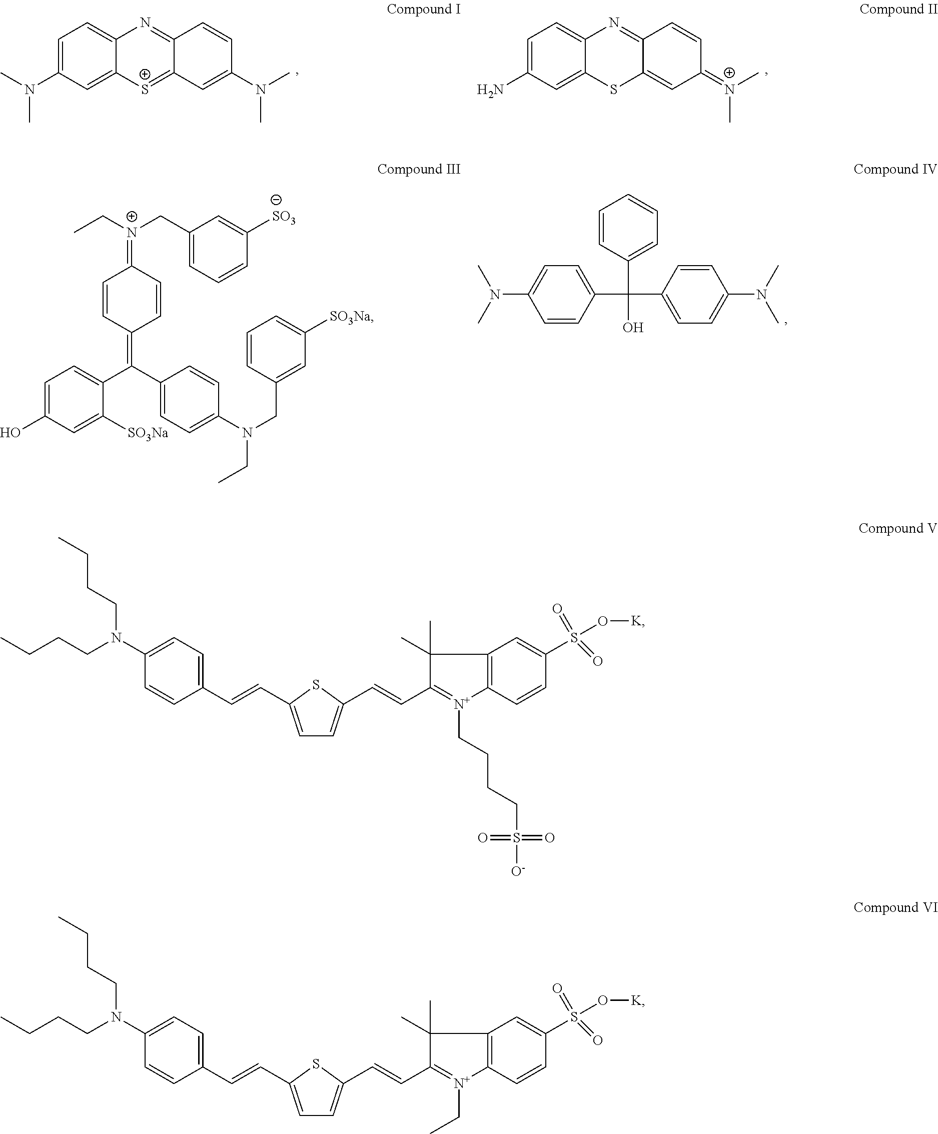

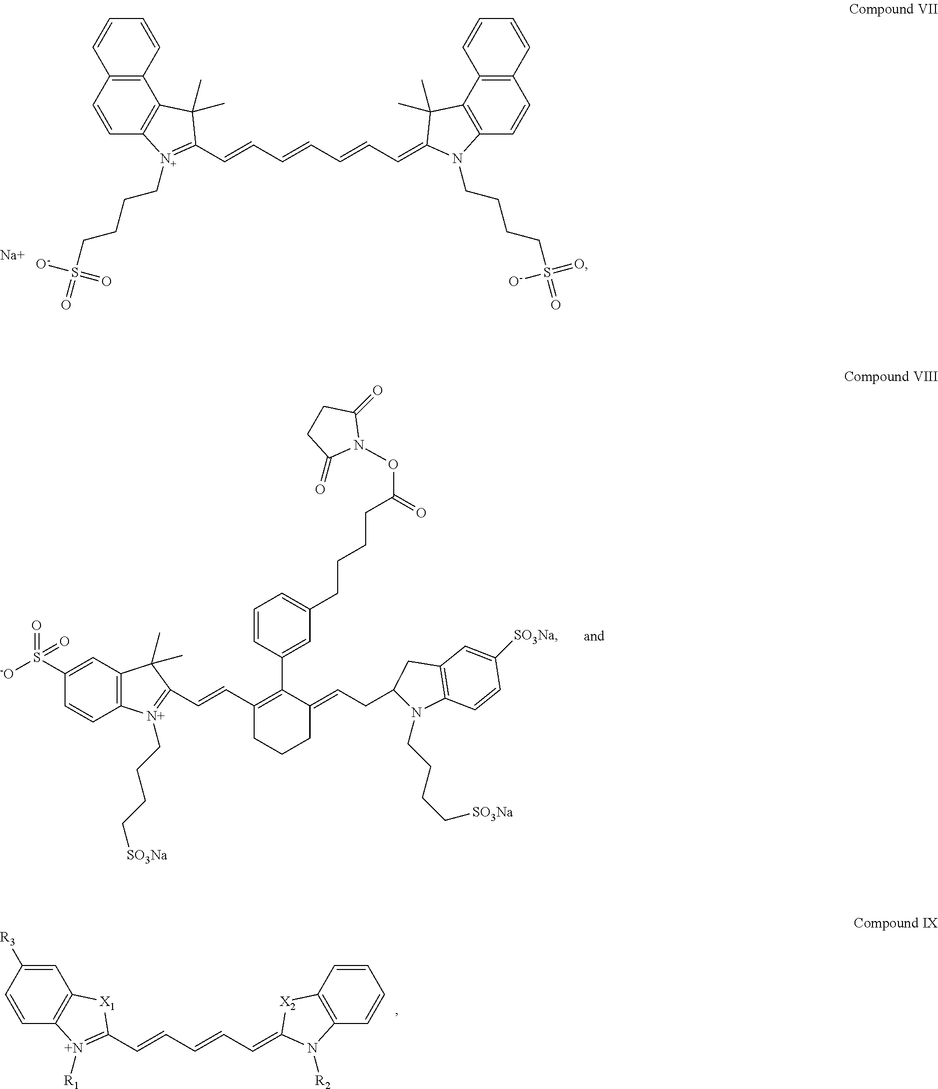

wherein X₁ and X₂ are independently CH₂ or C(CH₃) 2; R¹ and R² are independently H or (CH₂)₄SO₃Na, and R³ is H or SO₃Na.

In non-limiting illustrative embodiments, as may be combined with one or more of the preceding paragraphs, the red-light blocking compound is represented by one of the following compounds:

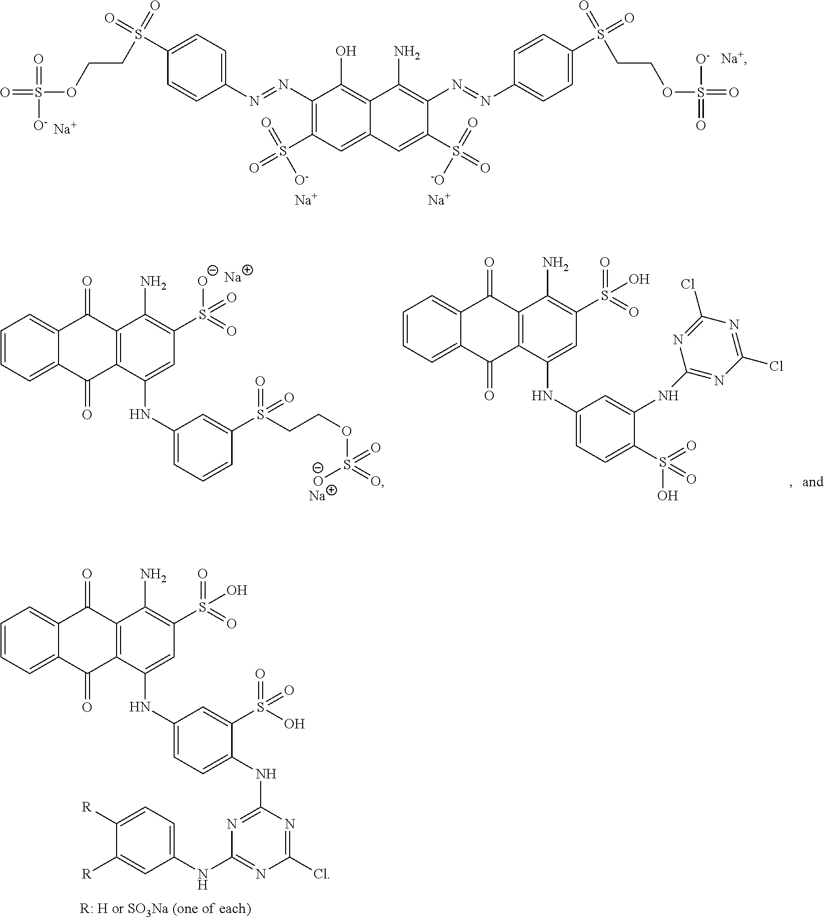

In non-limiting illustrative embodiments, as may be combined with one or more of the preceding paragraphs, the red-light blocking compound is represented by a structure as follows:

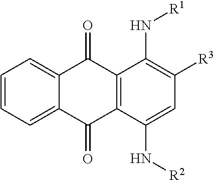

wherein R¹ and R² are hydrogen or an ethylenically unsaturated reactive end group, with at least one of R¹ and R² being an ethylenically unsaturated reactive end group; and R³ is hydrogen or a sulfonate group.

In non-limiting illustrative embodiments, as may be combined with one or more of the preceding paragraphs, the red-light blocking compound is represented by a structure as follows:

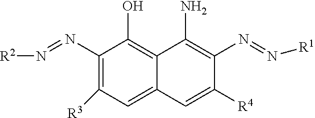

wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

In non-limiting illustrative embodiments, as may be combined with one or more of the preceding paragraphs, the ethylenically unsaturated reactive end group is a methacrylate-containing reactive end group represented by a structure as follows:

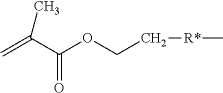

wherein R* is a linking group or bond, wherein the linking group is a divalent hydrocarbon radical.

In non-limiting illustrative embodiments, as may be combined with one or more of the preceding paragraphs, the method further comprises:
dispensing a contact lens-forming mixture comprising a contact lens-forming material into the contact lens mold having the colored pattern,
curing the contact lens-forming mixture comprising the contact lens-forming material to form a colored contact lens, whereby the colored pattern detaches from the molding surface and becomes integral with the body of the silicone contact lens, the colored pattern extending across a portion of the area of the iris section in a geometrical configuration to provide from about 95% to about 98% blocking of red-light transmission through the colored contact lens at a wavelength of from about 550 nm to about 800 nm, and hydrating the colored contact lens.

In non-limiting illustrative embodiments, as may be combined with one or more of the preceding paragraphs, the colored contact lens is a colored silicone contact lens.

In non-limiting illustrative embodiments, as may be combined with one or more of the preceding paragraphs, the colored contact lens is a colored non-silicone hydrogel.

In non-limiting illustrative embodiments, as may be combined with one or more of the preceding paragraphs, the colored pattern comprises a geometrical configuration comprising one or more red-light blocking concentric rings.

In non-limiting illustrative embodiments, as may be combined with one or more of the preceding paragraphs, the colored pattern comprises one or more red-light blocking concentric rings and one or more non-light blocking concentric rings surrounding the pupil section.

According to still yet another aspect of the present disclosure a method for slowing, inhibiting or preventing myopia progression in a subject in need thereof comprises inserting the colored contact lens according to any of the illustrative embodiments of theone or more of the preceding paragraphs into an eye of the subject.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A red-light blocking ink binder, comprising:
(a) a solvent;
(b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, with (ii) a monomer having a reactive functionality complementary to the hydroxyl moiety of the hydroxyethyl acrylate monomer and a polymerizable ethylenically unsaturated reactive end group; and
(c) a red-light blocking compound blocking from about 95% to about 98% of red-light transmission through a colored contact lens at a wavelength of from about 550 nanometers (nm) to about 800 nm.

2. The red-light blocking ink binder according to claim 1, wherein the alkylacrylamide monomer is N,N-dimethylacrylamide.

3. The red-light blocking ink binder according to claim 1, wherein the non-bulky organosilicon-containing monomer is represented by a following structure: 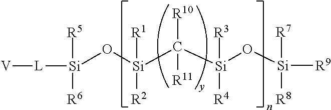
wherein V is an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure: 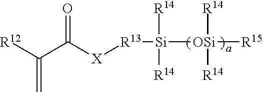
wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

4. The red-light blocking ink binder according to claim 1, wherein the bulky siloxane monomer is represented by a following structure: 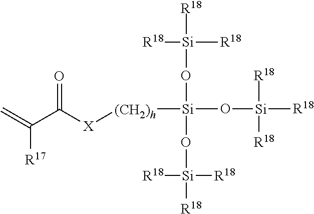
wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure: 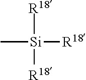
wherein each R¹⁸′ independently denotes a lower alkyl radical or a phenyl radical; and his 1 to 10;
or the following structure: 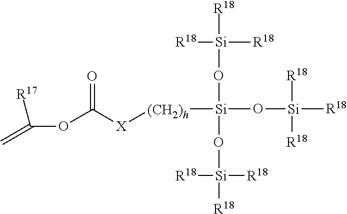
wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure: 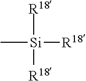
wherein each R¹⁸′ independently denotes a lower alkyl radical or a phenyl radical; and h is 1 to 10.

5. The red-light blocking ink binder according to claim 1, wherein the monomer having a reactive functionality complementary to the hydroxyl moiety of the hydroxyethyl acrylate monomer and a polymerizable ethylenically unsaturated reactive end group is selected from the group consisting of 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and vinyl chloroformate.

6. The red-light blocking ink binder according to claim 1, wherein the silicone copolymer comprises:
about 50 to about 400 repeating units of monomeric units derived from the alkylacrylamide monomer;
about 50 to about 200 repeating units of monomeric units derived from the hydroxyethyl acrylate monomer;
about 5 to about 20 repeating units of monomeric units derived from the hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group;
about 20 to about 300 repeating units of monomeric units derived from the non-bulky organosilicon-containing monomer having an ethylenically unsaturated reactive end group; and
about 1 to about 400 repeating units of monomeric units derived from the bulky siloxane monomer having an ethylenically unsaturated reactive end group.

7. The red-light blocking ink binder according to claim 1, wherein the red-light blocking compound is represented by one of the following compounds: 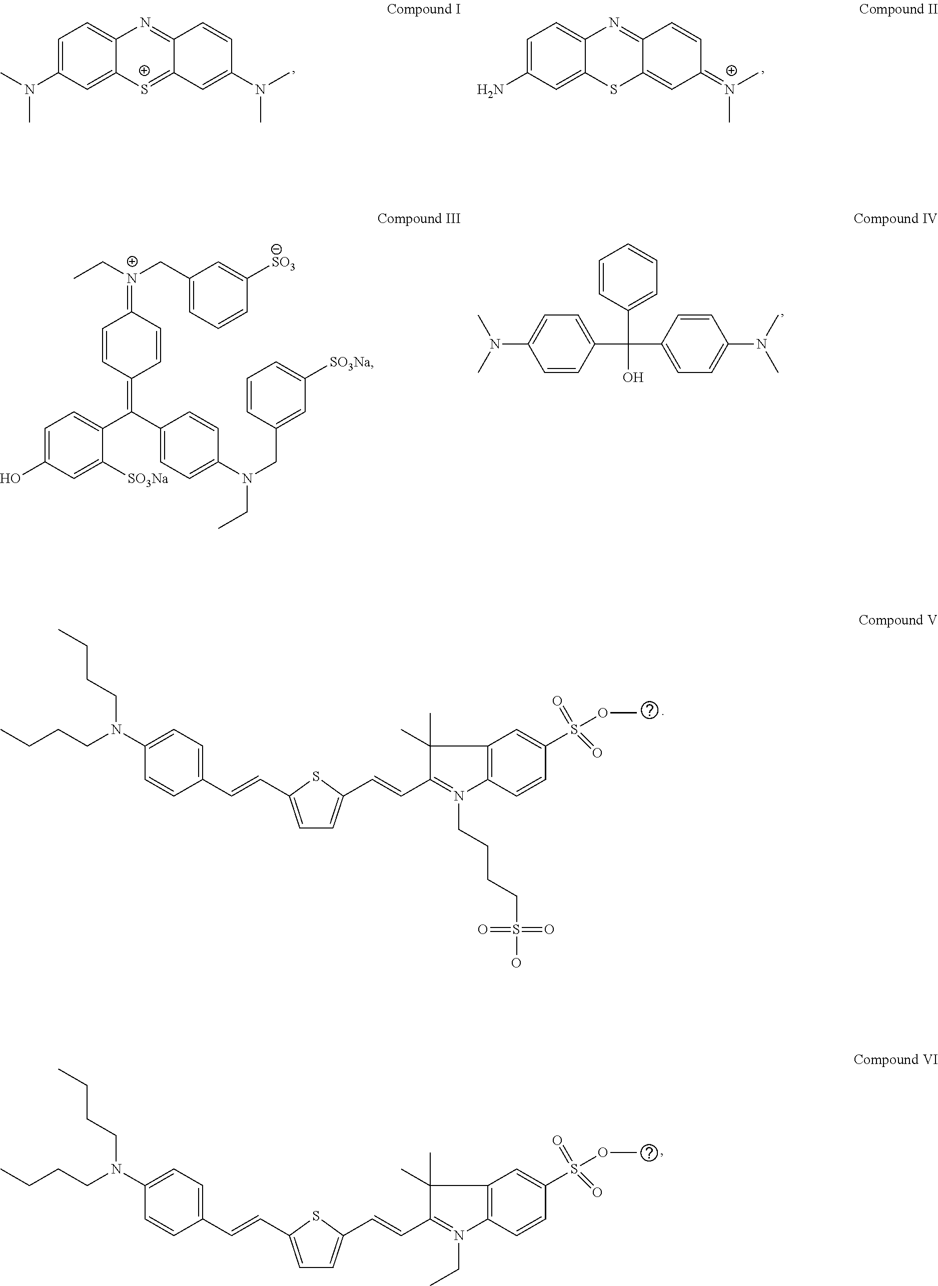 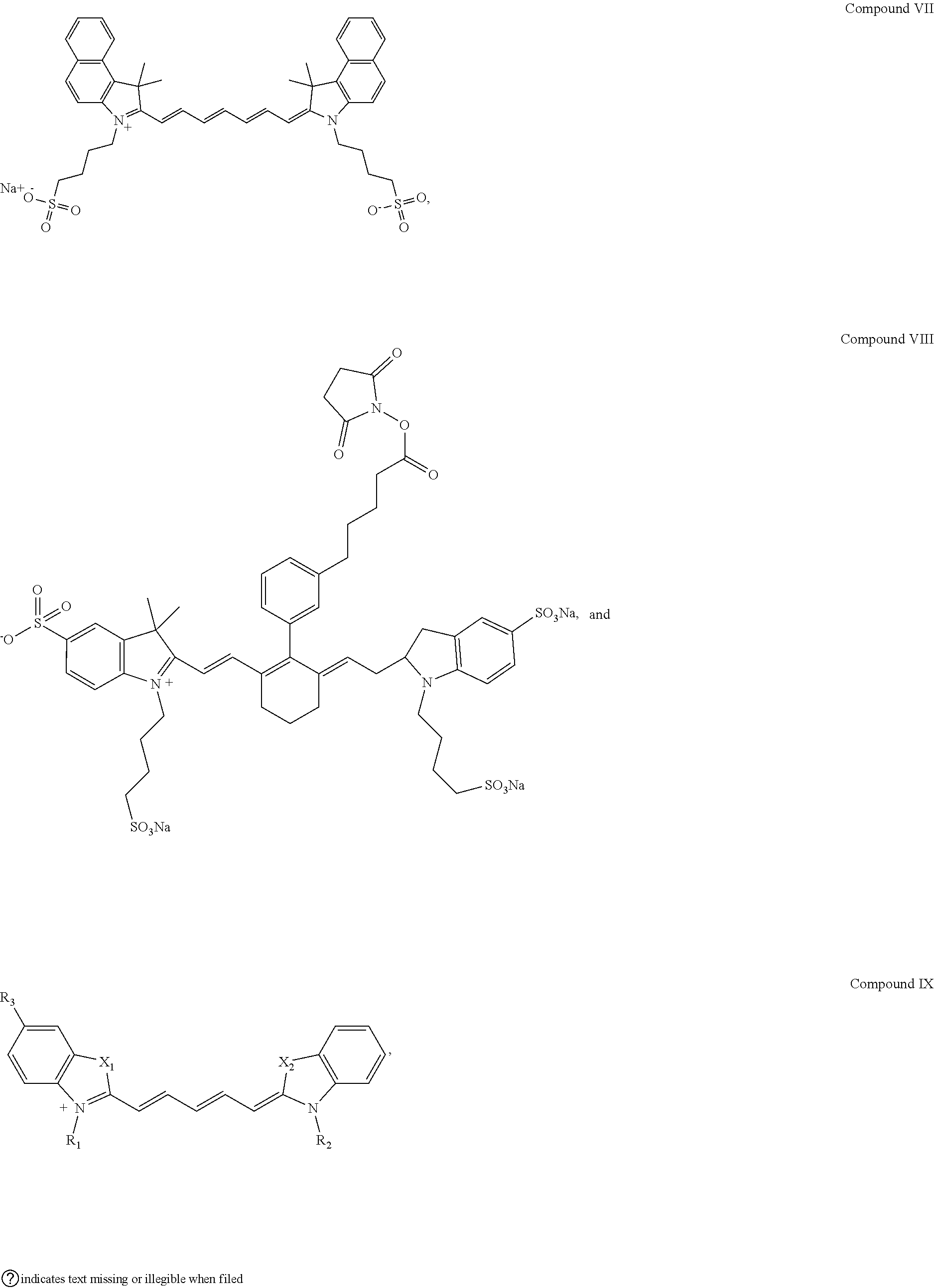
wherein X₁ and X₂ are independently CH₂ or C(CH₃)₂; R₁ and R₂ are independently H or (CH₂)₄SO₃Na, and R₃ is H or SO₃Na.

8. The red-light blocking ink binder according to claim 1, wherein the red-light blocking compound is represented by one of the following compounds:

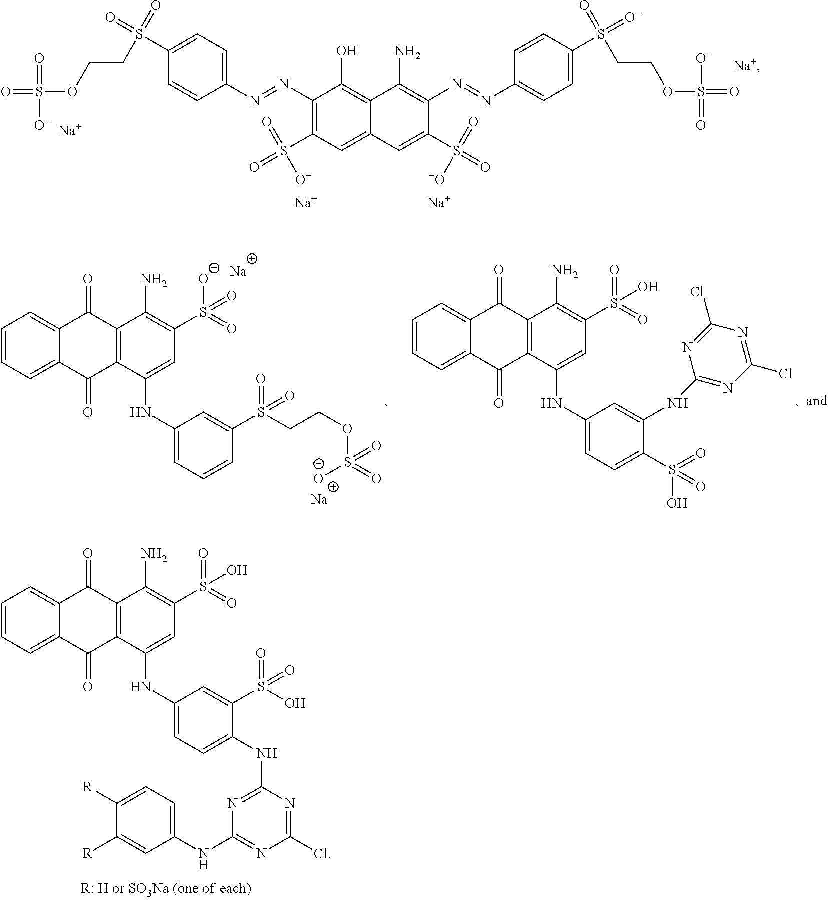

9. The red-light blocking ink binder according to claim 1, wherein the red-light blocking compound is represented by a structure as follows: 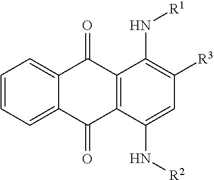
wherein R¹ and R² are hydrogen or an ethylenically unsaturated reactive end group, with at least one of R¹ and R² being an ethylenically unsaturated reactive end group; and R³ is hydrogen or a sulfonate group, or a structure as follows: 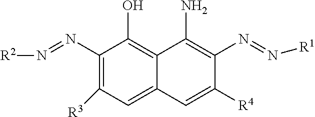
wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

10. A colored contact lens, comprising:
a pupil section;
an iris section having an area and circumferentially surrounding the pupil section; and
a colored pattern extending across a portion of the area of the iris section in a geometrical configuration to provide from about 95% to about 98% blocking of red-light transmission through the colored contact lens at a wavelength of from about 550 nanometers (nm) to about 800 nm, the colored pattern comprising a polymerization product of a red-light blocking ink binder comprising (a) a solvent, (b) a silicone copolymer comprising a reaction product of (i) a copolymerization product of a polymerization composition comprising (1) an alkylacrylamide monomer, (2) a hydroxyethyl acrylate monomer, (3) a non-bulky organosilicon-containing monomer having an ethylenically unsaturated reactive end group, and (4) a bulky siloxane monomer having an ethylenically unsaturated reactive end group, and (c) a red-light blocking compound blocking from about 95% to about 98% of red-light transmission through the colored contact lens at a wavelength of from about 550 nm to about 800 nm, with (ii) a monomer having a reactive functionality complementary to the hydroxyl moiety of the hydroxyethyl acrylate monomer and a polymerizable ethylenically unsaturated reactive end group, and (c) a red-light blocking compound blocking from about 95% to about 98% of red-light transmission through the colored contact lens at the wavelength of from about 550 nm to about 800 nm through a colored contact lens.

11. The colored contact lens according to claim 10, wherein the alkylacrylamide monomer is N,N-dimethylacrylamide, the non-bulky organosilicon-containing monomer is represented by a following structure: 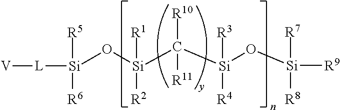
wherein V is an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure: 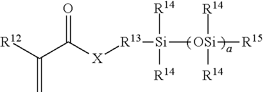
wherein R¹² is H or methyl; X is O or NR¹⁶; wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50, and the bulky siloxane monomer is represented by a following structure: 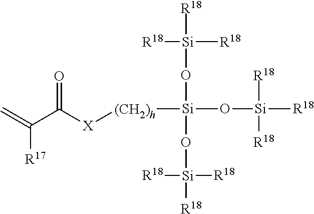
wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure: 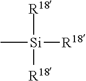
wherein each R¹⁸′ independently denotes a lower alkyl radical or a phenyl radical; and his 1 to 10; or the following structure: 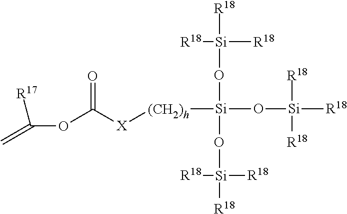
wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure: 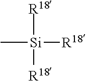
wherein each R¹⁸′ independently denotes a lower alkyl radical or a phenyl radical; and h is 1 to 10.

12. The colored contact lens according to claim 10, wherein the monomer having a reactive functionality complementary to the hydroxyl moiety of the hydroxyethyl acrylate monomer and a polymerizable ethylenically unsaturated reactive end group is selected from the group consisting of 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and vinyl chloroformate.

13. The colored contact lens according to claim 10, wherein the silicone copolymer comprises:
about 50 to about 400 repeating units of monomeric units derived from the alkylacrylamide monomer;
about 50 to about 200 repeating units of monomeric units derived from the hydroxyethyl acrylate monomer;
about 5 to about 20 repeating units of monomeric units derived from the hydroxyethyl acrylate monomer where the acrylate moiety is attached to the backbone of the copolymer and the hydroxy moiety is end functionalized with a monomer having a reactive functionality complementary to the hydroxyl moiety of the hydroxyethyl acrylate and a polymerizable ethylenically unsaturated reactive end group;
about 20 to about 300 repeating units of monomeric units derived from the non-bulky organosilicon-containing monomer having an ethylenically unsaturated reactive end group; and
about 1 to about 400 repeating units of monomeric units derived from the bulky siloxane monomer having an ethylenically unsaturated reactive end group.

14. The colored contact lens according to claim 10, wherein the red-light blocking compound is represented by one of the following compounds: 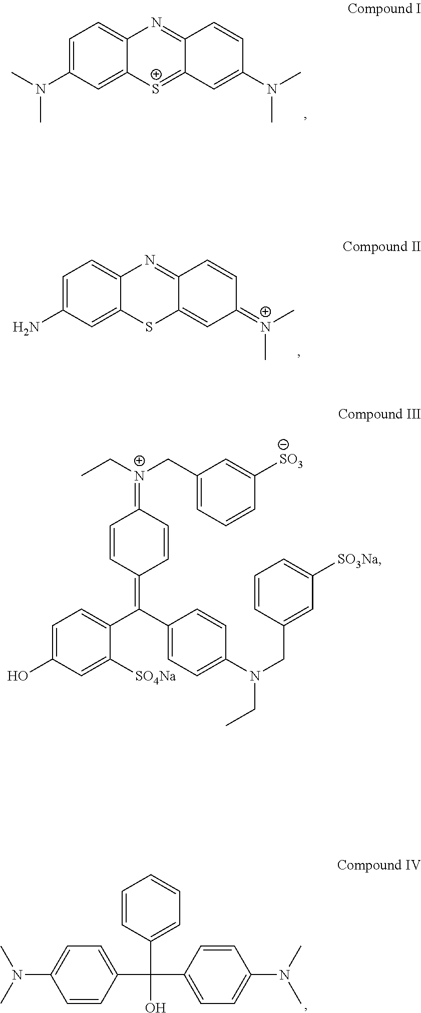 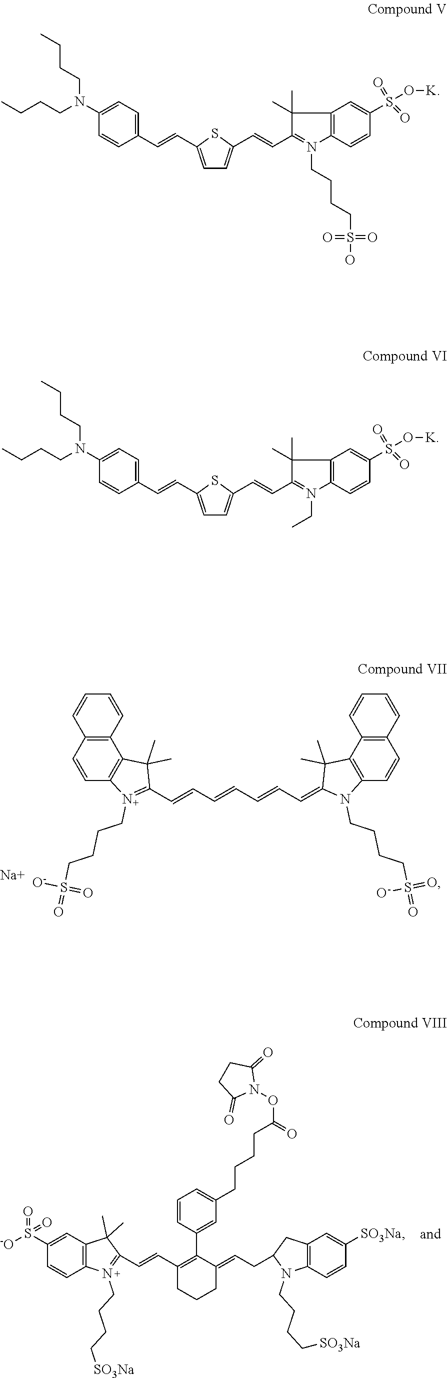 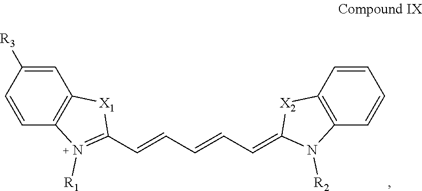
wherein X₁ and X₂ are independently CH₂ or C(CH₃) 2; R¹ and R² are independently H or (CH₂)₄SO₃Na, and R³ is H or SO₃Na.

15. The colored contact lens according to claim 10, wherein the red-light blocking compound is represented by one of the following compounds:

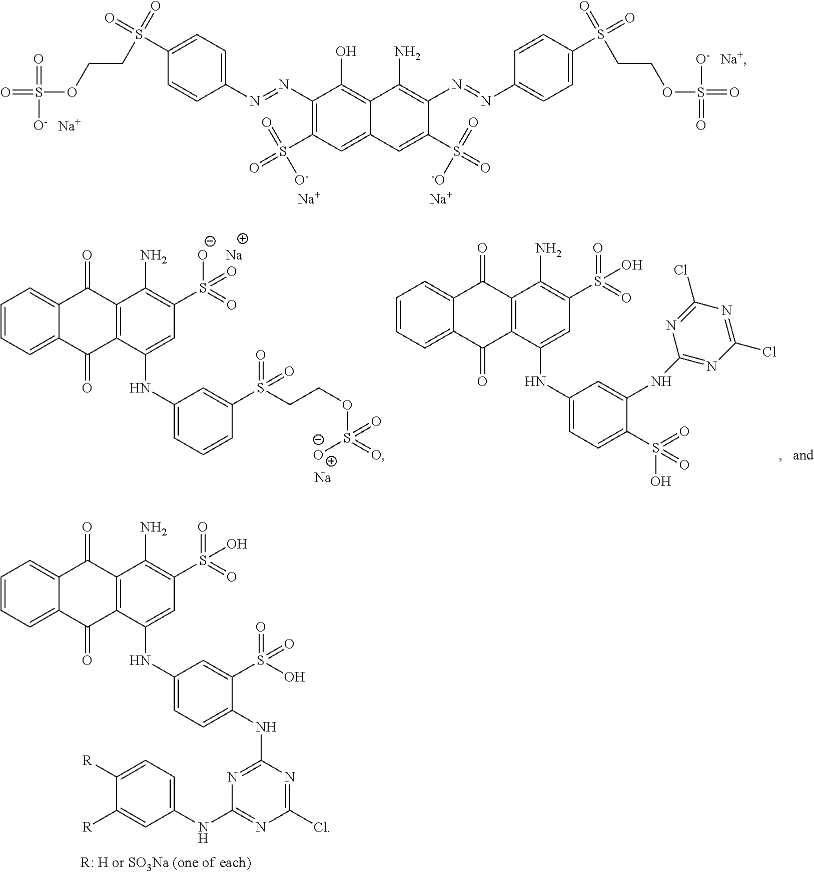

16. The colored contact lens according to claim 10, wherein the red-light blocking compound is represented by a structure as follows: 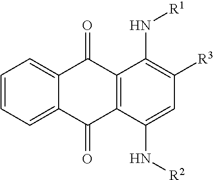
wherein R¹ and R² are hydrogen or an ethylenically unsaturated reactive end group, with at least one of R¹ and R² being an ethylenically unsaturated reactive end group; and R³ is hydrogen or a sulfonate group, or a structure as follows: 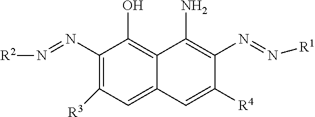
wherein R¹ and R² are hydrogen or an ethylenically unsaturated reactive end group, with at least one of R¹ and R² being an ethylenically unsaturated reactive end group; and R³ and R⁴ are independently hydrogen or a sulfonate group.

17. The colored contact lens according to claim 10, wherein the colored pattern comprises a geometrical configuration comprising one or more red-light blocking concentric rings.

18. A method, comprising:
(a) applying, to at least a portion of a molding surface of a contact lens mold, a red-light blocking ink binder comprising (i) a solvent, (ii) a silicone copolymer comprising a reaction product of (1) a copolymerization product of a polymerization composition comprising (i1) an alkylacrylamide monomer, (12) a hydroxyethyl acrylate monomer, (i3) a non-bulky organosilicon-containing monomer having an ethylenically unsaturated reactive end group, and (14) a bulky siloxane monomer having an ethylenically unsaturated reactive end group, with (2) a monomer having a reactive functionality complementary to the hydroxyl moiety of the hydroxyethyl acrylate monomer and a polymerizable ethylenically unsaturated reactive end group, and (iii) a red-light blocking compound blocking from about 95% to about 98% of red-light transmission through a colored contact lens at a wavelength of from about 550 nanometers (nm) to about 800 nm; and
(b) curing the red-light blocking ink binder to form a colored pattern which comprises a red-light blocking polymer network comprising the red-light blocking compound in the polymer network, wherein the colored pattern contains a first surface in contact with the molding surface and an exposed second surface.

19. The method according to claim 18, wherein the alkylacrylamide monomer is N,N-dimethylacrylamide, the non-bulky organosilicon-containing monomer is represented by a following structure: 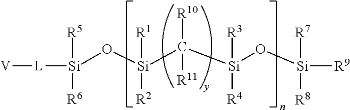
wherein Vis an ethylenically unsaturated polymerizable group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure: 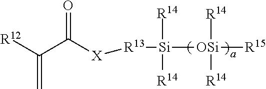
wherein R¹² is H or methyl; X is O or NR¹⁶; wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50, and the bulky siloxane monomer is represented by a following structure: 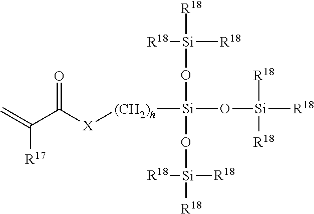
wherein X denotes —O— or —NR¹⁹— where each R¹⁹ is hydrogen or a C₁-C₄ alkyl; R¹⁷ independently denotes hydrogen or methyl; each R¹⁸ independently denotes a lower alkyl radical, a phenyl radical or a group represented by the following structure: 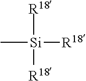
wherein each R¹⁸′ independently denotes a lower alkyl radical or a phenyl radical; and his 1 to 10; or the following structure: 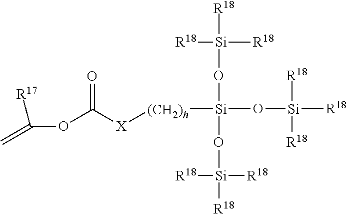
wherein X denotes —NR¹⁹—; wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure: 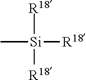
wherein each R¹⁸′ independently denotes a lower alkyl radical or a phenyl radical; and h is 1 to 10.

20. The method according to claim 18, further comprising:
dispensing a contact lens-forming mixture comprising a contact lens-forming material into the contact lens mold having the colored pattern;
curing the contact lens-forming mixture comprising the contact lens-forming material to form a colored contact lens, whereby the colored pattern detaches from the molding surface and becomes integral with the body of the silicone contact lens, the colored pattern extending across a portion of the area of the iris section in a geometrical configuration to provide from about 95% to about 98% blocking of red-light transmission through the colored contact lens at a wavelength of from about 550 nm to about 800 nm; and
hydrating the colored contact lens.
